(19) United States
(12) Patent Application Publication
(10) Pub. No.: US 2026/0161831 A1
(43) Pub. Date: Jun. 11, 2026

(54) CHIPLET SYSTEM HAVING A PLURALITY OF CHIPLETS AND SECURING METHOD THEREOF

(71) Applicant: REBELLIONS INC., Seongnam-si (KR)

(72) Inventors: Myunghoon CHOI, Seongnam-si (KR); Chang-Hyo YU, Seongnam-si (KR)

(21) Appl. No.: 19/179,960

(22) Filed: Apr. 15, 2025

(30) Foreign Application Priority Data
Jun. 5, 2024 (KR) 10-2024-0073702

(51) Int. Cl. G06F 21/72; G06F 9/455; G06F 21/60; G06F 21/64; H04L 9/14

(52) U.S. Cl. CPC G06F 21/72; G06F 9/45558; G06F 21/602; G06F 21/64; H04L 9/14; G06F 2009/45583; G06F 2009/45587

(57) ABSTRACT

A chiplet system including a plurality of chiplets is disclosed. The chiplet system includes a first chiplet comprising a first interface for communicating with a first external device and a first RoT (root of trust) in which tamper-resistant first data is stored, and a second chiplet comprising a second interface for communicating with a first memory, a second RoT in which tamper-resistant second data is stored, and a first computation module that performs computation using data stored in the first memory.

### CROSS-REFERENCE TO RELATED APPLICATION

This application claims priority to Korean Patent Application No. 10-2024-0073702, filed in the Korean Intellectual Property Office on Jun. 5, 2024, the entire contents of which are hereby incorporated by reference.

### BACKGROUND

### Technical Field

The present disclosure relates to a chiplet system including a plurality of chiplets and a method of securing the same.

### Description of Related Art

With increasing demands for high performance and miniaturization of semiconductor devices and electronic products using the semiconductor devices, various package-related technologies have been developed. As part of such technological developments, package technology using chiplets is recently emerging.

A chiplet system may be understood as having a plurality of dies (chiplets), each die configured by subdividing functional units, rather than configuring a chip (that performs various functions) as a single die (or substrate), and then packaging these dies as a single unit. That is, a chiplet system is designed to overcome the limitations of a conventional monolithic chip. The dies in the package can be connected through a silicon interposer, and communication can be performed according to a die-to-die communication standard such as UCIe (universal chiplet interconnect express).

Because such chiplets can be scaled down by subdividing functional units, limitations on the reticle size (i.e., the reticle that prints circuits on the surface of a wafer using light in a semiconductor photo process) can be overcome. Also, as the semiconductor yield tends to be inversely proportional to area, the use of chiplets may increase semiconductor yield and reduce manufacturing costs. Accordingly, there is an increasing demand to use chiplets in manufacturing electronic products, and technical developments are also being sought for a method of securing a chiplet system that includes a plurality of chiplets.

### SUMMARY

The present disclosure provides a chiplet system including a plurality of chiplets and a security method thereof, which address the aforementioned issues.

The present disclosure may be embodied in various forms, including a method, a device (system), and/or a computer program stored in a computer-readable storage medium.

According to an embodiment of the present disclosure, a chiplet system including a plurality of chiplets may comprise: a first chiplet including a first interface for communicating with a first external device and a first RoT (root of trust) in which tamper-resistant first data is stored; and a second chiplet including a second interface for communicating with a first memory, a second RoT in which tamper-resistant second data is stored, and a first computation module configured to perform computations using data stored in the first memory. The first chiplet may be configured to obtain, from the second chiplet, through a third interface for communication between the first chiplet and the second chiplet, information on a security state of the second chiplet based on the second data, generate, based on information on a security state of the first chiplet based on the first data and the information on a security state of the second chiplet obtained from the second chiplet, first monitoring information, and transmit the first monitoring information to the first external device through the first interface.

According to an embodiment, the chiplet system may further comprise a third chiplet including a fourth interface for communication with a second memory, a third RoT in which tamper-resistant third data is stored, and a second computation module that performs computations using data stored in the second memory. The first chiplet may be further configured to obtain, from the third chiplet, through a fifth interface for communication between the second chiplet and the third chiplet, and the third interface, information on a security state of the third chiplet based on the third data, and the first monitoring information may be generated based on the information on the security state of the first chiplet based on the first data, the information on the security state of the second chiplet obtained from the second chiplet, and the information on the security state of the third chiplet obtained from the third chiplet.

According to an embodiment, the chiplet system may further comprise a fourth chiplet including a sixth interface for communicating with a third memory, a fourth RoT in which tamper-resistant fourth data is stored, and a third computation module that performs computations using data stored in the third memory. The first chiplet may be further configured to obtain, from the fourth chiplet, through a seventh interface for communication between the third chiplet and the fourth chiplet, the fifth interface, and the third interface, information on a security state of the fourth chiplet based on the fourth data, and the first monitoring information may be generated based on the information on the security state of the first chiplet based on the first data, the information on the security state of the second chiplet obtained from the second chiplet, the information on a security state of the third chiplet obtained from the third chiplet, and the information on a security state of the fourth chiplet obtained from the fourth chiplet.

According to an embodiment, the first chiplet may be configured to, in response to receiving a request associated with resource allocation for a virtual machine, allocate a computation resource that processes computation associated with the virtual machine to the first computation module while allocating a memory resource that stores data of the computation associated with the virtual machine to the first memory and the second memory. The second chiplet may grant, based on the second data, an encryption key associated with security of data stored in the first memory and data stored in the second memory to the virtual machine.

According to an embodiment, the first chiplet may be configured to, in response to receiving a request associated with resource allocation for a virtual machine, allocate a computation resource that processes computation associated with the virtual machine to the first computation module and a second computation module while allocating a memory resource that stores data of the computation associated with the virtual machine to the first memory and the second memory. The second chiplet may grant, based on the second data, an encryption key associated with security of data stored in the first memory and data stored in the second memory to the virtual machine and may share the encryption key with the third chiplet, and the third chiplet may be configured to perform, based on the third data, security process on data stored in the second memory by using the shared encryption key.

According to an embodiment, the first chiplet may be configured to, in response to receiving a request associated with resource allocation for a first virtual machine and a second virtual machine, allocate a computation resource that processes computation associated with the first virtual machine to the first computation module while allocating a memory resource that stores data of the computation associated with the first virtual machine to the first memory, and allocate a computation resource that processes computation associated with the second virtual machine to the second computation module while allocating a memory resource that stores data of the computation associated with the second virtual machine to the second memory. The second chiplet may be configured to grant, based on the second data, a first encryption key associated with security of data stored in the first memory to the first virtual machine, and the third chiplet may be configured to grant, based on the third data, a second encryption key associated with security of data stored in the second memory to the second virtual machine.

According to an embodiment, the first chiplet may be further configured to, in response to receiving a request associated with resource allocation for a first virtual machine and a second virtual machine, allocate a computation resource that processes computations associated with the first virtual machine and the second virtual machine to the first computation module while allocating a memory resource that stores data of computations associated with both the first virtual machine and the second virtual machine to the first memory. The second chiplet may be configured to grant, based on the second data, a first encryption key associated with security of data that is associated with the first virtual machine among data stored in the first memory to the first virtual machine, and may grant, based on the second data, a second encryption key associated with security of data related to the second virtual machine among data stored in the first memory to the second virtual machine.

According to an embodiment, the chiplet system may further comprise a third chiplet including a fourth interface for communicating with a second external device and a third RoT in which tamper-resistant third data is stored, and a fourth chiplet including a fifth interface for communicating with a second memory, a fourth RoT in which tamper-resistant fourth data is stored, and a second computation module that performs computation using data stored in the second memory. The third chiplet may be configured to obtain, through a sixth interface for communication between the third chiplet and the fourth chiplet, information on a security state of the fourth chiplet based on the fourth data, generate, based on information on a security state of the third chiplet based on the third data and the information on the security state of the fourth chiplet obtained from the fourth chiplet, second monitoring information, and transmit the second monitoring information to the second external device through the fourth interface.

According to an embodiment, the chiplet system may further comprise a third chiplet including a fourth interface for communicating with the first chiplet and a third RoT in which tamper-resistant third data is stored, and a fourth chiplet including a fifth interface for communicating with a second memory, a fourth RoT in which tamper-resistant fourth data is stored, and a second computation module that performs computation using data stored in the second memory. The third chiplet may be configured to obtain, from the fourth chiplet, through a sixth interface for communication between the third chiplet and the fourth chiplet, information on a security state of the fourth chiplet based on the fourth data, generate, based on information on a security state of the third chiplet based on the third data and the information on the security state of the fourth chiplet obtained from the fourth chiplet, second monitoring information, and may transmit the second monitoring information to the first chiplet through the fourth interface. The first monitoring information may be generated based on information on a security state of the first chiplet based on the first data, information on a security state of the second chiplet obtained from the second chiplet, and the second monitoring information obtained from the third chiplet.

According to an embodiment, the information on the security state of the first chiplet may include at least one of information on integrity verification of firmware operating in the first chiplet or information on real-time integrity verification of at least a portion of data being used in the first chiplet, and the information on the security state of the second chiplet may include at least one of information on integrity verification of firmware operating in the second chiplet or information on real-time integrity verification of at least a portion of data used in the second chiplet.

A security method for a chiplet system including a plurality of chiplets according to an embodiment of the present disclosure, the chiplet system comprising a first chiplet comprising a first interface for communicating with a first external device and a first RoT (root of trust) in which tamper-resistant first data is stored, and a second chiplet comprising a second interface for communicating with a first memory, a second RoT in which tamper-resistant second data is stored, and a first computation module that performs computation using data stored in the first memory, the method comprising obtaining, by the first chiplet, from the second chiplet, through a third interface for communication between the first chiplet and the second chiplet, information on a security state of the second chiplet based on the second data, generating, by the first chiplet, based on information on a security state of the first chiplet based on the first data and the information on the security state of the second chiplet obtained from the second chiplet, first monitoring information, and transmitting, by the first chiplet, the first monitoring information to the first external device through the first interface.

According to an embodiment, the security method of the chiplet system may further comprise obtaining, by the first chiplet, from a third chiplet, through a fifth interface for communication between the second chiplet and a third chiplet, and the third interface, information on a security state of the third chiplet based on the third data, wherein the third chiplet comprises a fourth interface for communicating with a second memory, a third RoT in which tamper-resistant third data is stored, and a second computation module that performs computation using data stored in the second memory, and the generating the first monitoring information comprises generating, by the first chiplet, based on the information on the security state of the first chiplet based on the first data, the information on the security state of the second chiplet obtained from the second chiplet, and the information on the security state of the third chiplet obtained from the third chiplet, the first monitoring information.

According to an embodiment, the security method of the chiplet system may further comprise obtaining, by the first chiplet, from the fourth chiplet, through a seventh interface between the third chiplet and a fourth chiplet, the fifth interface, and the third interface, information on a security state of the fourth chiplet based on the fourth data, wherein the fourth chiplet comprises a sixth interface for communicating with a third memory, a fourth RoT in which tamper-resistant fourth data is stored, and a third computation module that performs computation using data stored in the third memory, the generating the first monitoring information comprises generating, by the first chiplet, the first monitoring information, based on the information on the security state of the first chiplet based on the first data, the information on the security state of the second chiplet obtained from the second chiplet, the information on the security state of the third chiplet obtained from the third chiplet, and the information on the security state of the fourth chiplet obtained from the fourth chiplet.

According to an embodiment, the security method of the chiplet system may further comprise, in response to receiving a request associated with resource allocation for a virtual machine, allocating, by the first chiplet, a computation resource that processes computation associated with the virtual machine to the first computation module while allocating a memory resource that stores data of the computation associated with the virtual machine to the first memory and the second memory, and granting, by the second chiplet, based on the second data, an encryption key associated with security of data stored in the first memory and data stored in the second memory to the virtual machine.

According to an embodiment, the security method of the chiplet system may further comprise, in response to receiving a request associated with resource allocation for a virtual machine, allocating, by the first chiplet, a computation resource that processes computation associated with the virtual machine to the first computation module and the second computation module while allocating a memory resource that stores data of the computation associated with the virtual machine to the first memory and the second memory, granting, by the second chiplet, based on the second data, an encryption key associated with security of data stored in the first memory and in the second memory to the virtual machine, sharing, by the second chiplet, the encryption key with the third chiplet, and performing, by the third chiplet based on the third data, security process on data stored in the second memory by using the shared encryption key.

According to an embodiment, the security method of a chiplet system may further comprise, in response to receiving a request associated with resource allocation for a first virtual machine and a second virtual machine, allocating, by the first chiplet, a computation resource that processes computation associated with the first virtual machine to the first computation module while allocating a memory resource that stores data of the computation associated with the first virtual machine to the first memory, and allocating a computation resource that processes computation associated with the second virtual machine to the second computation module while allocating a memory resource that stores data of the computation associated with the second virtual machine to the second memory, granting, by the second chiplet, based on the second data, a first encryption key associated with security of data stored in the first memory to the first virtual machine, and granting, by the third chiplet, based on the third data, a second encryption key associated with security of data stored in the second memory to the second virtual machine.

According to an embodiment, the security method of the chiplet system may further comprise, in response to receiving a request associated with resource allocation for a first virtual machine and a second virtual machine, allocating, by the first chiplet, a computation resource that processes computations associated with the first virtual machine and the second virtual machine to the first computation module while allocating a memory resource that stores data of the computations associated with the first virtual machine and the second virtual machine to the first memory; and granting, by the second chiplet, based on the second data, a first encryption key associated with security of data that is associated with the first virtual machine among the data stored in the first memory to the first virtual machine, and a second encryption key associated with security of data that is associated with the second virtual machine among the data stored in the first memory to the second virtual machine.

According to an embodiment, the security method of the chiplet system may further comprise obtaining, by the third chiplet, from the fourth chiplet, through a sixth interface for communication between a third chiplet and a fourth chiplet, information on a security state of the fourth chiplet based on the fourth data, wherein the third chiplet comprises a fourth interface for communicating with a second external device and a third RoT in which tamper-resistant third data is stored, and the fourth chiplet comprises a fifth interface for communicating with a second memory, a fourth RoT in which tamper-resistant fourth data is stored, and a second computation module that performs computation using data stored in the second memory, generating, by the third chiplet, based on information on a security state of the third chiplet based on the third data and the information on the security state of the fourth chiplet obtained from the fourth chiplet, second monitoring information, and transmitting, by the third chiplet, the second monitoring information to the second external device through the fourth interface.

According to an embodiment, the security method of the chiplet system may further comprise obtaining, by the third chiplet, from the fourth chiplet, through a sixth interface for communication between a third chiplet and a fourth chiplet, information on a security state of the fourth chiplet based on the fourth data, wherein the third chiplet comprises a fourth interface for communicating with the first chiplet and a third RoT in which tamper-resistant third data is stored, and the fourth chiplet comprises a fifth interface for communicating with a second memory, a fourth RoT in which tamper-resistant fourth data is stored, and a second computation module that performs computation using data stored in the second memory, generating, by the third chiplet, based on information on a security state of the third chiplet based on the third data and the information on the security state of the fourth chiplet obtained from the fourth chiplet, second monitoring information; and transmitting, by the third chiplet, the second monitoring information to the first chiplet through the fourth interface. In that case, the generating the first monitoring information comprises generating, by the first chiplet, based on information on the security state of the first chiplet based on the first data, information on the security state of the second chiplet obtained from the second chiplet, and the second monitoring information obtained from the third chiplet, the first monitoring information.

According to some embodiments of the present disclosure, security performance in a chiplet system including a plurality of chiplets can be improved. In particular, in a heterogeneous chiplet system including a separate chiplet for input/output functionality, optimization of hardware resources can be achieved while also enhancing security performance.

The effects of the present disclosure are not limited to the aforementioned, and other effects not explicitly stated will be clearly understood by those of ordinary skill in the art from the description in the claims.

### BRIEF DESCRIPTION OF THE DRAWINGS

Embodiments of the present disclosure will be described with reference to the accompanying drawings, in which like reference numerals refer to like elements, but are not limited thereto.

FIG. 1 illustrates a diagram for describing a configuration of a chiplet system including a plurality of chiplets according to an embodiment of the present disclosure.

FIG. 2 illustrates a diagram showing an example of an electronic device according to an embodiment of the present disclosure.

FIG. 3 illustrates a diagram for describing a configuration of a chiplet according to an embodiment of the present disclosure.

FIG. 4 illustrates a diagram for describing a configuration for performing integrity verification in a chiplet according to an embodiment of the present disclosure.

FIG. 5 illustrates a diagram for describing a configuration for security of a chiplet system including a plurality of chiplets according to an embodiment of the present disclosure.

FIG. 6 illustrates a diagram for describing a configuration for security of a plurality of sub-chiplet systems according to an embodiment of the present disclosure.

FIG. 7A illustrates another configuration for security of a plurality of sub-chiplet systems according to an embodiment of the present disclosure.

FIG. 7B illustrates yet another configuration for security of a plurality of sub-chiplet systems according to an embodiment of the present disclosure.

FIG. 8 illustrates a diagram for describing a configuration for resource allocation and data security for a virtual machine according to an embodiment of the present disclosure.

FIG. 9 illustrates another configuration for resource allocation and data security for a virtual machine according to an embodiment of the present disclosure.

FIG. 10 illustrates yet another configuration for resource allocation and data security for a virtual machine according to an embodiment of the present disclosure.

FIG. 11 illustrates a diagram for describing a security method for a chiplet system including a plurality of chiplets according to an embodiment of the present disclosure.

FIG. 12 illustrates a diagram for describing a security method for a plurality of chiplet systems according to an embodiment of the present disclosure.

FIG. 13 illustrates a diagram for describing a method for resource allocation and data security for a virtual machine according to an embodiment of the present disclosure.

FIG. 14 illustrates another method for resource allocation and data security for a virtual machine according to an embodiment of the present disclosure.

FIG. 15 illustrates a diagram for describing a method for resource allocation and data security for a plurality of virtual machines according to an embodiment of the present disclosure.

FIG. 16 illustrates another method for resource allocation and data security for a plurality of virtual machines according to an embodiment of the present disclosure.

### DETAILED DESCRIPTION

Hereinafter, detailed descriptions will be provided with reference to the accompanying drawings for the specific content to implement embodiments of the present disclosure. However, in the following description, well-known functions or configurations will be omitted if they would unnecessarily obscure the gist of the present disclosure.

In the accompanying drawings, the same or corresponding components are denoted by the same reference numerals. In addition, in the descriptions of the following embodiments, repeated explanations of the same or corresponding components may be omitted. However, even if the description of components is omitted, it does not imply that such components are not included in a certain embodiment.

The advantages and features of the disclosed embodiments and methods of achieving them will become clear by referring to the embodiments described below together with the accompanying drawings. However, the present disclosure is not limited to the embodiments described below and may be implemented in many different forms, and these embodiments are provided merely so that this disclosure is complete, and so that one of ordinary skill in the art can fully understand the scope of the present disclosure.

Brief explanations regarding terms used in the present specification will be provided, followed by a detailed description of the disclosed embodiments. The terms used in the present specification were chosen, as far as possible, from widely used general terms in consideration of the functions of the present disclosure, but the terms may vary according to the intent of one skilled in the art, court rulings, newly emerging technology, etc. In certain cases, some terms were arbitrarily selected by the applicant, in which case their meaning will be described in detail in the corresponding portion of the present specification. Therefore, the terms used in the present disclosure should not be viewed merely as the name of a term, but should be defined based on the meaning of the term and the content throughout the present disclosure.

Expressions in the singular number in the present specification include expressions in the plural number unless clearly specified as singular in context. Likewise, expressions in the plural number include expressions in the singular number unless clearly specified as plural in context. In the entire specification, if a portion is described as including a certain component, this indicates it may further include other components, unless there is specific contrary recitation.

Further, the term “module” or “unit” as used in the present specification refers to software and/or hardware components that perform a certain role, but is not limited to software or hardware. A “module” or “unit” may be configured to reside in an addressable storage medium and configured to be executed by one or more processors. For example, “module” or “unit” may include software components such as object-oriented software components, class components, and task components, as well as processes, functions, attributes, procedures, subroutines, segments of program code, drivers, firmware, microcode, circuits, data, databases, data structures, tables, arrays, or variables. The components and “module” or “unit” may be combined into fewer components, modules, or units, or may be further separated into additional components, modules, or units.

According to an embodiment of the present disclosure, a “module” or a “unit” may be realized using a processor and a memory. A “processor” should be broadly interpreted to include, for example, a general-purpose processor, a central processing unit (CPU), a microprocessor, a digital signal processor (DSP), a controller, a microcontroller, or a state machine. In some environments, a “processor” may also refer to an ASIC (application-specific integrated circuit), a PLD (programmable logic device), or an FPGA (field-programmable gate array). A “processor” may also refer to a combination of processing devices such as a combination of a DSP and a microprocessor, a combination of multiple microprocessors, a combination of one or more microprocessors coupled with a DSP core, or any other such configuration. In addition, “memory” should be broadly interpreted to include any electronic component capable of storing electronic information. “Memory” may refer to various types of processor-readable media such as RAM, ROM, NVRAM, PROM, EPROM, EEPROM, flash memory, magnetic or marking data storage devices, registers, and the like. A memory is in electronic communication with the processor when the processor can read information from and/or write information to the memory. A memory that is integrated into a processor is in electronic communication with the processor.

Further, in the following embodiments, terms such as first, second, A, B, (a), and (b) are used to distinguish one component from another, and the essence, order, or sequence of those components is not limited by the use of these terms.

Moreover, in the following embodiments, if a component is described as being “connected” or “coupled” with another component, it should be understood that the component may be directly connected or coupled to that other component, or another component may be interposed therebetween.

Furthermore, in the following embodiments, the terms “comprises” and/or “comprising” do not exclude the presence or addition of one or more other components, steps, operations, and/or elements, unless specifically stated otherwise.

In addition, in the following embodiments, “each of a plurality of A” may refer to each of all components included in the plurality of A, or it may refer to each of some components included in the plurality of A.

Various embodiments of the present disclosure will now be described in detail with reference to the accompanying drawings.

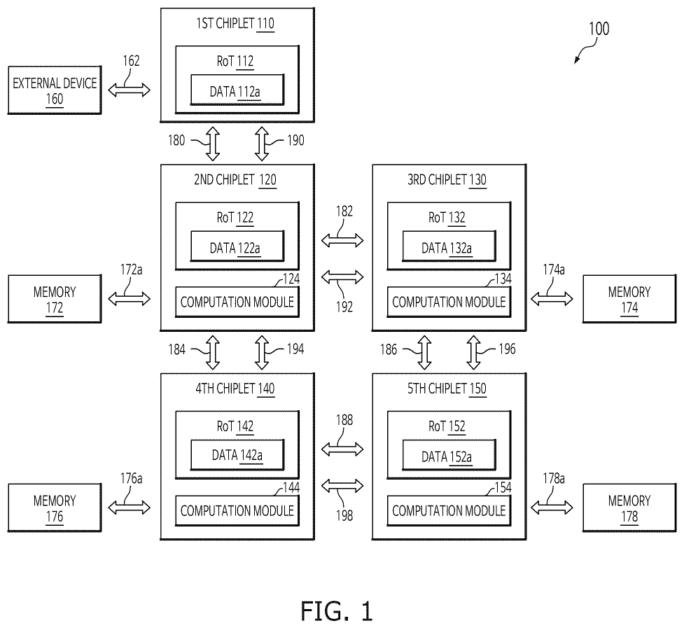

FIG. 1 illustrates a diagram for describing a configuration of a chiplet system 100 including a plurality of chiplets 110, 120, 130, 140, 150 according to an embodiment of the present disclosure. Referring to FIG. 1, the chiplet system 100 may include a plurality of chiplets. For example, the chiplet system 100 may include a first chiplet 110, a second chiplet 120, a third chiplet 130, a fourth chiplet 140, and a fifth chiplet 150. However, the number of chiplets included in the chiplet system 100 is not limited thereto. Various embodiments may omit at least one of the above-mentioned chiplets or may further include at least one other chiplet. The chiplet system 100 including a plurality of chiplets may be packaged, and thus may be referred to as a packaging device.

The chiplet system 100 may be a homogeneous chiplet system, formed by connecting multiple chiplets having the same structure or function, or a heterogeneous chiplet system that includes at least one chiplet among the plurality of chiplets with a different structure or function. In the case of a heterogeneous chiplet system, it is possible to implement an optimized design by assigning hardware resources suitable for the purpose of each chiplet. For example, if the entire chiplet system includes a separate chiplet in charge of input/output (I/O) functionality, a chiplet in charge of computation functionality (e.g., neural network computing) may remove or not include an interface for communication with a host (e.g., a PCIe or Ethernet interface), so that hardware resources can be optimized at the level of the entire chiplet system. In the description below, descriptions will be given for a case in which the chiplet system 100 is configured as a system that includes at least one heterogeneous chiplet.

The plurality of chiplets 110, 120, 130, 140, 150 included in the chiplet system 100 may be connected to each other via first interfaces 180, 182, 184, 186, 188. For example, the first chiplet 110 and the second chiplet 120 may be connected via the first interface 180, the second chiplet 120 and the third chiplet 130 may be connected via the first interface 182, the second chiplet 120 and the fourth chiplet 140 may be connected via the first interface 184, the third chiplet 130 and the fifth chiplet 150 may be connected via the first interface 186, and the fourth chiplet 140 and the fifth chiplet 150 may be connected via the first interface 188. In an embodiment, the first interfaces 180, 182, 184, 186, 188 may be die-to-die interfaces, for example including UCIe or the like.

Among the plurality of chiplets 110, 120, 130, 140, 150 included in the chiplet system 100, one chiplet (e.g., the first chiplet 110) may be connected to an external device 160 (e.g., a host device) via a second interface 162. In this case, the remaining chiplets (e.g., the second chiplet 120, the third chiplet 130, the fourth chiplet 140, and the fifth chiplet 150) may have communication with the external device 160 restricted. For example, in a heterogeneous chiplet system, the first chiplet 110 may be in charge of input/output functionality with the external device 160, while the second chiplet 120, the third chiplet 130, the fourth chiplet 140, and the fifth chiplet 150 may be in charge of functionality other than input/output (e.g., computation functionality or memory expansion functionality). In one embodiment, except for the first chiplet 110 responsible for input/output functionality, the remaining chiplets (e.g., the second chiplet 120, the third chiplet 130, the fourth chiplet 140, and the fifth chiplet 150) may be homogeneous chiplets having the same structure and function, or at least one may be a heterogeneous chiplet with a different structure or function. In an embodiment, the second interface 162 may be a host interface, for example PCIe, Ethernet, or CXL (Compute Express Link).

According to an embodiment, the plurality of chiplets 110, 120, 130, 140, 150 included in the chiplet system 100 may be connected to each other via third interfaces 190, 192, 194, 196, 198. For example, the first chiplet 110 and the second chiplet 120 may be connected via the third interface 190, the second chiplet 120 and the third chiplet 130 may be connected via the third interface 192, the second chiplet 120 and the fourth chiplet 140 may be connected via the third interface 194, the third chiplet 130 and the fifth chiplet 150 may be connected via the third interface 196, and the fourth chiplet 140 and the fifth chiplet 150 may be connected via the third interface 198. In an embodiment, these third interfaces 190, 192, 194, 196, 198 may be backup interfaces that have lower data transmission speed than the first interfaces 180, 182, 184, 186, 188 used for chiplet-to-chiplet connection. For example, the third interfaces 190, 192, 194, 196, 198 may include secure JTAG (secure Joint Test Action Group), GPIO (general-purpose input/output), and I2C (Inter-Integrated Circuit). Also, the third interfaces 190, 192, 194, 196, 198 may be utilized for input/output communication with the outside of a chiplet. For example, the third interfaces 190, 192, 194, 196, 198 may include SPI (Serial Peripheral Interface) or UART (Universal Asynchronous Receiver/Transmitter).

According to an embodiment, the chiplet system 100 can perform parallel processing for at least some functionalities. For example, a host device (such as the external device 160) may manage the chiplet system 100 and distribute tasks related to at least some functionalities to the chiplet system 100, and the chiplet system 100 may process these distributed tasks in parallel. This can optimize and improve the overall system performance, including the host device and the chiplet system 100, and provide a scalable computing environment. In an embodiment, the chiplet system 100 may perform functions such as a multi-processor, a memory controller, a cache, and a network interface.

In an embodiment, in the chiplet system 100, the chiplets other than the first chiplet 110 (which is in charge of I/O with the external device 160), i.e., the second chiplet 120, the third chiplet 130, the fourth chiplet 140, and the fifth chiplet 150, may be responsible for computation using data stored in memories 172, 174, 176, 178 that are respectively connected to these chiplets. To this end, each of the second chiplet 120, the third chiplet 130, the fourth chiplet 140, and the fifth chiplet 150 may communicate with a corresponding memory 172, 174, 176, 178 via a fourth interface 172a, 174a, 176a, 178a, respectively, and may include a computation module 124, 134, 144, 154 configured to perform computations using data stored in the corresponding memory 172, 174, 176, 178. Each memory 172, 174, 176, 178 may be, for example, a DRAM (dynamic random access memory). Further, in an embodiment, each computation module 124, 134, 144, 154 may perform AI (artificial intelligence) computations and may thus include an NPU (neural processing unit) cluster having multiple neural engines.

For security functionality in the chiplet system 100 that includes the plurality of chiplets 110, 120, 130, 140, 150, each of the plurality of chiplets 110, 120, 130, 140, 150 may include an RoT (root of trust) 112, 122, 132, 142, 152. For example, the RoT 112, 122, 132, 142, 152 included in each of the plurality of chiplets 110, 120, 130, 140, 150 may perform integrity verification of firmware that operates in the chiplet and/or real-time integrity verification of at least a portion of data in use in that chiplet. For this security functionality, each RoT 112, 122, 132, 142, 152 may include tamper-proof data 112a, 122a, 132a, 142a, 152a. The tamper-proof data 112a, 122a, 132a, 142a, 152a may include encryption keys, security states, security firmware, and the like, and each RoT may manage security processes in a chiplet. For example, an RoT may control so that only a program (e.g., firmware) and data that pass integrity verification can operate and be processed in that chiplet; if integrity verification fails (for example, if program and/or data tampering is found), the RoT can safely operate the chiplet system 100 through a recovery process. In an embodiment, each RoT 112, 122, 132, 142, 152 may be physically separated from the main core of the chiplet. Also, each RoT 112, 122, 132, 142, 152 may be included in a security core, and the tamper-proof data 112a, 122a, 132a, 142a, 152a may include encryption keys (or security keys), security data (e.g., hash values), and so on.

Although not shown in FIG. 1, each of the plurality of chiplets 110, 120, 130, 140, 150 may include a processor (e.g., a CPU) for general operation and instruction processing within the chiplet. A CPU may belong to a main core domain and may have limited access rights to a security core domain, while each RoT may belong to the security core domain and may perform operations and instruction processing related to the security of the chiplet, having access rights to all areas of the chiplet.

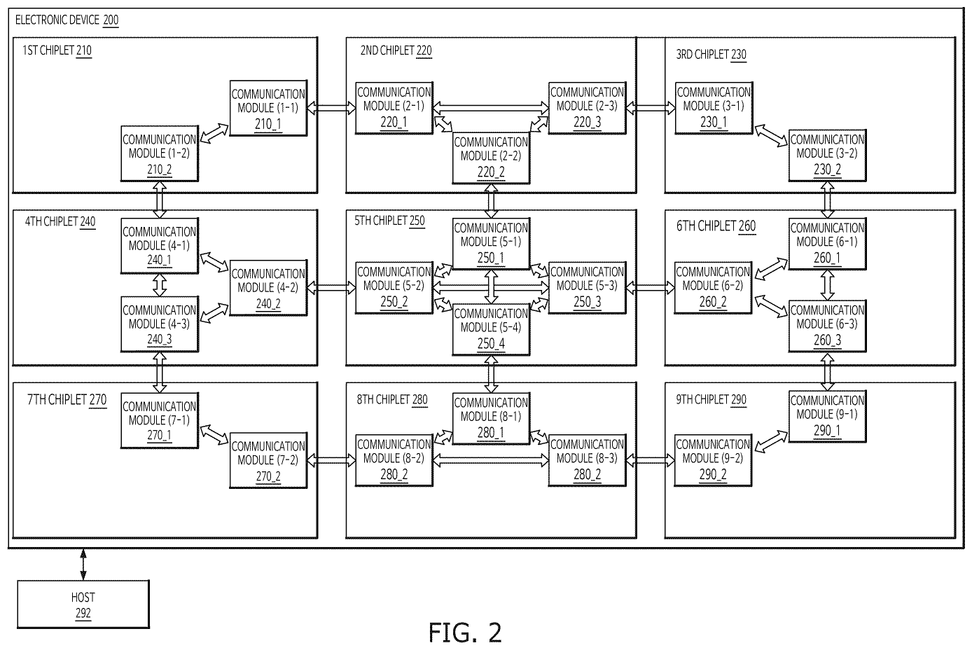

FIG. 2 illustrates a diagram showing an example of an electronic device 200 according to an embodiment of the present disclosure. Referring to FIG. 2, the electronic device 200 (e.g., an electronic device that includes the chiplet system 100 of FIG. 1) may include a plurality of chiplets. For example, the electronic device 200 may include a first chiplet 210, a second chiplet 220, a third chiplet 230, a fourth chiplet 240, a fifth chiplet 250, a sixth chiplet 260, a seventh chiplet 270, an eighth chiplet 280, and a ninth chiplet 290. However, the number of chiplets included in the electronic device 200 is not limited thereto. Various embodiments may omit at least one of the above-mentioned chiplets or further include at least one other chiplet. Also, the arrangement of the chiplets in the electronic device 200 is not limited to what is shown and may be arranged in various manners depending on the intended purpose. The electronic device 200 including a plurality of chiplets may be packaged, and thus may be referred to as a package device or a chiplet system.

Each of the plurality of chiplets may include one or more processing cores, memory, input/output interfaces, power management circuits, control logic, ADCs (Analog-to-Digital Converters), DACs (Digital-to-Analog Converters), and so forth.

Each of the plurality of chiplets may include one or more communication modules. In one embodiment, each chiplet among the plurality of chiplets may include one or more communication modules that can communicate with other adjacent chiplets among the plurality of chiplets. For example, the first chiplet 210 may include a first-1 communication module 210_1 and a first-2 communication module 210_2; the second chiplet 220 may include a second-1 communication module 220_1, a second-2 communication module 220_2, and a second-3 communication module 220_3. Further, the fifth chiplet 250 may include a fifth-1 communication module 250_1, a fifth-2 communication module 250_2, a fifth-3 communication module 250_3, and a fifth-4 communication module 250_4. Chiplets including the same number of communication modules may be implemented under the same architecture. For example, the fourth chiplet 240 and the sixth chiplet 260 may be implemented under the same architecture but connected to other chiplets in different directions. For instance, the fourth-1 communication module 240_1 and the sixth-1 communication module 260_1, the fourth-2 communication module 240_2 and the sixth-2 communication module 260_2, and the fourth-3 communication module 240_3 and the sixth-3 communication module 260_3 may correspond to each other.

Alternatively, each of the plurality of chiplets may include the same number of communication modules. For example, not only the fifth chiplet 250 but also each of the plurality of chiplets included in the electronic device 200 may include four communication modules, and for convenience of description in FIG. 2, a communication module in a direction adjacent to no other chiplet may be omitted.

A communication module may include a controller and a PHY layer. A communication module may include a connection management module or a connection module.

The plurality of chiplets may be connected to each other via the communication modules and connection interfaces (indicated by arrows between the communication modules of different chiplets in FIG. 2). For example, the fifth chiplet 250 and the eighth chiplet 280 may be connected via the fifth-4 communication module 250_4, the eighth-1 communication module 280_1, and an interface. In an embodiment, the chiplet-to-chiplet connection interface may be a die-to-die interface, for example, including UCIe, etc.

Within each of the plurality of chiplets, the communication modules may be connected to each other via a bus interface (indicated by arrows between communication modules within the same chiplet in FIG. 2). For example, the third-1 communication module 230_1 and the third-2 communication module 230_2 within the third chiplet 230 may be connected via a bus interface, and likewise the ninth-1 communication module 290_1 and the ninth-2 communication module 290_2 within the ninth chiplet 290 may be connected via a bus interface. Additionally, not limited to communication between communication modules, each component within a chiplet may communicate with other components via a bus interface. In one embodiment, the bus interface may be an AXI (Advanced eXtensible Interface)-type interface. For example, each communication module in the plurality of chiplets may be connected to one another through an AXI Master port and an AXI Slave port, each of which may include a read port and a write port.

Using each chiplet's communication module, connection interface, and/or bus interface, information may be transmitted and received within the electronic device 200. For example, if information is delivered from the fourth chiplet 240 to the ninth chiplet 290, the information may may pass sequentially through the fourth-3 communication module 240_3, the seventh-1 communication module 270_1, the seventh-2 communication module 270_2, the eighth-2 communication module 280_2, the eighth-3 communication module 280_3, and the ninth-2 communication module 290_2 before reaching the ninth chiplet 290. Alternatively, if information is transmitted from the fourth chiplet 240 to the ninth chiplet 290, the information may pass sequentially through the fourth-2 communication module 240_2, the fifth-2 communication module 250_2, the fifth-3 communication module 250_3, the sixth-2 communication module 260_2, the sixth-3 communication module 260_3, and the ninth-1 communication module 290_1 before reaching the ninth chiplet 290. The path for delivering information from one chiplet to another may be determined by the architecture of the chiplet system or by various routing algorithms such as Dijkstra's algorithm or the Bellman-Ford algorithm, but is not limited thereto.

One chiplet (e.g., the first chiplet 210) among the plurality of chiplets may be connected to an external device (e.g., a host 292) via a host interface. In that case, the other chiplets (e.g., the second chiplet 220, etc.) may have restricted communication with the external device. The chiplet (e.g., the first chiplet 210) that communicates with an external device may be referred to as a main chiplet, a primary die, a base chiplet, an I/O die, or an I/O chiplet, while the remaining chiplets (e.g., the second chiplet 220), which have restricted communication with the external device, may be referred to as sub-chiplets, secondary dies, partner chiplets, and so on, and depending on functionality, if the chiplet performs computation functions, it may be referred to as a compute die or compute chiplet, etc. In an embodiment, the host interface connecting the host 292 and the electronic device 200 (or the main chiplet) may be PCIe or the like.

In an embodiment, the electronic device 200 (i.e., the chiplet system) including the plurality of chiplets may perform at least some functions in parallel. For example, the host 292 (or a host system) (e.g., the external device 160 in FIG. 1) may manage the chiplet system and distribute tasks related to at least some functions to the chiplet system, and the chiplet system may process these tasks in parallel. This may optimize and improve overall system performance of the host 292 and the chiplet system, and provide a scalable computing environment. In an embodiment, the chiplet system may perform functions such as multi-processor, memory controller, cache, and network interface.

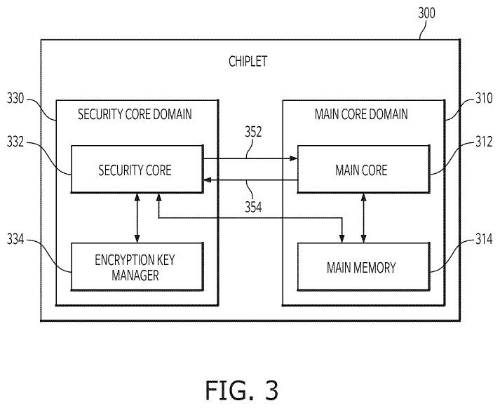

FIG. 3 illustrates a diagram for describing the configuration of a chiplet 300 according to an embodiment of the present disclosure. Referring to FIG. 3, a chiplet 300 (e.g., any one of the first chiplet 110, the second chiplet 120, the third chiplet 130, the fourth chiplet 140, or the fifth chiplet 150 in FIG. 1) included in the chiplet system (e.g., the chiplet system 100 in FIG. 1) may be divided into a main core domain 310 and a security core domain 330. The main core domain 310 may include a main core 312 and a main memory 314, and the security core domain 330 may include a security core 332 and an encryption key manager 334. However, the configuration of the chiplet 300 is not limited thereto. Various embodiments may omit at least one of the above-mentioned components or may include at least one other component.

The main core 312 may be a core that performs computational tasks. Additionally or alternatively, the main core 312 may be a core that manages or distributes computational tasks to other cores. For example, the main core 312 may load data stored in the main memory 314 and perform or drive processes such as computation on the data. However, the type or function of the main core 312 is not limited to this.

The main memory 314 may include a volatile memory belonging to the main core domain 310. The main memory 314 may store and/or process data and/or software during operation of the main core 312 and the security core 332. In other words, data in use may be stored in the main memory 314. In an embodiment, the main memory 314 may correspond to the memories 172, 174, 176, 178 discussed in FIG. 1. For example, the main memory 314 may store data used for AI computations.

The main core domain 310 may include the main core 312 and hardware and/or software regions used in the computational tasks of the main core 312. For example, the main core domain 310 may include the main memory 314.

The security core 332 may be a core that performs computational tasks for security purposes. Additionally or alternatively, the security core 332 may be a core that manages or distributes computational tasks for security purposes. For example, the security core 332 may periodically or aperiodically perform integrity verification of at least some data stored in the main memory 314. Moreover, because it may be necessary for the security core 332 to stop operation of the entire system except for the security core 332 itself when a security-related problem (e.g., a failure in integrity verification) arises, the security core 332 may have the highest priority among the cores in the chiplet 300. Under this configuration, the security core 332 may have access to all components of the chiplet 300.

In an embodiment, the security core 332, when accessing the main memory 314, may use direct memory access (DMA) dedicated to the security core to accelerate data traffic.

The encryption key manager 334 may be hardware and/or software configured to manage encryption keys related to encryption/decryption operations performed by the security core 332. For example, the encryption key manager 334 may be a block that generates and manages encryption keys. In an embodiment, encryption keys may be generated by a dedicated core (e.g., a key derivation core) inside the encryption key manager 334. The encryption key manager 334 may manage information on each encryption key (e.g., a mapping relationship between data and its encryption key).

Although not shown in FIG. 3, in an embodiment, a separate memory may exist within the security core domain 330. The memory in the security core domain 330 may include an area for storing encryption keys (e.g., keys generated by the encryption key manager 334 or keys received from outside the system) and individual encryption-key information. Access to this area may be permitted only to the encryption key manager 334. Additionally or alternatively, the encryption key manager 334 itself may include a dedicated memory, in which encryption keys and key information may be stored. The encryption keys and key information described above may correspond to the tamper-proof data (e.g., 112a, 122a, 132a, 142a, 152a) described in FIG. 1. Further, in FIG. 3, the encryption key manager 334 is illustrated as a component separate from the security core 332 for convenience in explanation; however, it is not limited thereto. In an embodiment, at least a portion of the encryption key manager 334 may be included in the security core 332. At least some portion of the configuration in the security core domain 330 (e.g., at least a portion of the security core 332 and/or the encryption key manager 334) may correspond to an RoT (e.g., RoT 112, 122, 132, 142, 152) discussed in FIG. 1.

The security core domain 330 may include the security core 332 and hardware and/or software regions utilized by the security core 332 for computational tasks. The security core domain 330 may include the encryption key manager 334. Because security-related tasks are performed in the security core domain 330, other configurations inside or outside the system may access the security core 332 only for limited purposes, such as to request access to encrypted data, and other access to the security core domain 330 may be restricted.

A security-main interconnection 352 may transfer data and/or control signals between the security core 332 and the main core 312. In this arrangement, the security core 332 may have a higher priority than the main core 312. Thus, the security core 332 may access all parts of the main core 312 and may control whether the main core 312 operates. Therefore, if a security-related problem arises, the security core 332 may stop operation of the main core 312 and take control of the entire system. Consequently, if data tampering is detected in the integrity verification process, the security core 332 can smoothly perform system protection and/or a recovery process.

A main-security interconnection 354 may transfer data and control signals between the main core 312 and the security core 332. In this case, through the main-security interconnection 354, the main core 312 may access only limited parts of the security core 332, thus the security of the security core 332 can be maintained, and the risk of tampering of the chiplet 300 can be prevented.

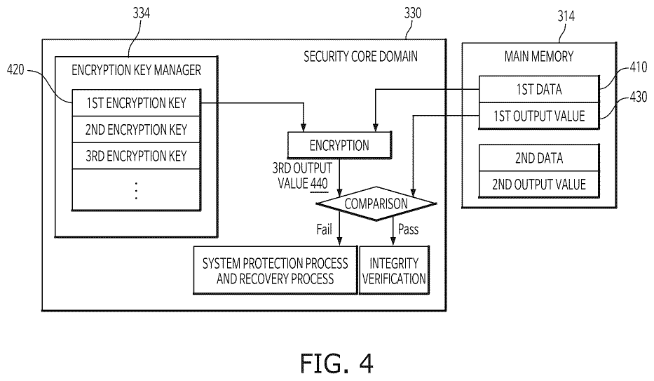

FIG. 4 illustrates a diagram for describing a configuration for performing integrity verification in a chiplet according to an embodiment of the present disclosure. Referring to FIG. 4, a security core (e.g., the security core 332 in FIG. 3) may periodically or aperiodically perform integrity verification on data stored in the main memory 314. As one example, the security core may perform integrity verification on firmware stored in the main memory 314. As another example, the security core may perform run-time integrity verification on at least some of the data stored in the main memory 314. The encryption key for use in integrity verification may be managed by an encryption key manager (e.g., the encryption key manager 334) inside the security core domain accessible by the security core. In an embodiment, the encryption key manager 334 may be accessible only by the security core, and may be inaccessible to other components internal or external to the system, except the security core.

In an embodiment, the security core may perform integrity verification only on a portion of the data stored in the main memory 314. For instance, the security core may perform integrity verification on data that has read-only characteristics and is not frequently undated and is frequently reused, such as firmware (e.g., boot firmware), page tables, or parameters of a trained machine learning model (e.g., kernel data of a trained neural network), but is not limited thereto.

The security core may use a one-way cryptographic algorithm for integrity verification. A one-way cryptographic algorithm may be an algorithm that guarantees that when the input changes, the output changes, and it is extremely difficult or impossible to derive the input from the output. Any known one-way cryptographic algorithm in the relevant field may be used for integrity verification. For example, the one-way cryptographic algorithm may include hash algorithms such as CRC, MD5, RIPEMD160, SHA-1, SHA-256, SHA-384, or SHA-512, but is not limited thereto. Herein, “output value” may refer to the output value of the cryptographic algorithm when data and the encryption key are input into the one-way cryptographic algorithm.

FIG. 4 illustrates an example in which integrity verification is performed on first data 410 stored in the main memory 314. In this example, the first data 410 is stored in the main memory 314 in association with a first output value 430 that is generated based on a first encryption key 420 (managed by the encryption key manager 334) and the one-way cryptographic algorithm. For example, the first output value 430 may be a hash value obtained by inputting the first data 410 and the first encryption key 420 into a hash algorithm. Matching information indicating that the first data 410 is associated with the first encryption key 420 may be managed by the encryption key manager 334 in the security core domain 330.

The first data 410 stored in the main memory 314 may come from various sources. For example, the first data 410 may be loaded from a nonvolatile memory accessible by the security core, or it may be data generated by the main core (e.g., the main core 312 in FIG. 3), or it may be data received from a host device (e.g., the external device 160 in FIG. 1). In an embodiment, the process of storing the first data 410 in the main memory 314 may differ depending on where the first data 410 originates. In some embodiments, if the first data 410 is loaded from a nonvolatile memory accessible by the security core or is received from a host device, the security core may first perform a preliminary integrity verification on the first data 410, and then store the first data 410 in the main memory 314.

For integrity verification, the security core may first generate, based on the first data 410 stored in the main memory 314 and the first encryption key 420 using a one-way cryptographic algorithm, a third output value 440 for the first data 410. For example, the security core may compute a hash value by inputting the first data 410 and the first encryption key 420 into a hash algorithm, thereby obtaining the first output value 430. In an embodiment, the security core may use a dedicated DMA for the security core to accelerate data traffic when loading data from or storing data to the main memory 314.

Next, the security core may compare the stored first output value 430 with the newly generated third output value 440 to check whether the first data 410 in the main memory 314 has been tampered with. The security core may perform such an integrity verification periodically or aperiodically.

If, as a result of checking for tampering, the first output value 430 and the third output value 440 do not match, the security core may determine that the first data 410 in the main memory 314 has been tampered with. If the first data 410 is determined to have been tampered with, the security core may perform a system protection process and a recovery process. If the first output value 430 and the third output value 440 match, the integrity of the first data 410 stored in the main memory 314 may be verified.

If the same key is continually used for integrity verification, the system may be exposed to security risks. In an embodiment, in order to avoid such exposure, the security core may periodically change the encryption key and regenerate and store the output value. For example, the security core may generate a new output value by applying the one-way cryptographic algorithm to the first data 410 and a second encryption key managed by the encryption key manager 334, and then store this new output value in association with the first data 410 in the main memory 314.

In an embodiment, the security core may use a public-key cryptography algorithm (or an asymmetric-key cryptography algorithm), e.g., ECDSA-384, for the cryptographic algorithm used in integrity verification. For instance, the security core may first perform a hash operation on the first data 410 (e.g., firmware). Then the security core may encrypt the hash operation result using a private key in a public-key cryptography algorithm. The encrypted result is the digital signature, which may be stored in the main memory 314 in association with the first data 410. Thereafter, the security core may perform the hash operation again on the first data 410 and decrypt the digital signature (stored in association with the first data 410) using a public key. If the hash operation result and the decrypted result match, the integrity of the first data 410 stored in the main memory 314 may be verified; if they do not match, the security core may determine that the first data 410 has been tampered with and may perform a system protection process and a recovery process.

In the system protection process according to an embodiment, the security core may stop the operation of the entire system except the security core. For example, if a run-time integrity verification determines that data (e.g., the first data 410) in the main memory 314 has been tampered with, the security core may immediately stop the operation of the entire system including the main core and initiate the system protection process. The main core may remain stopped until it receives a command from the security core to resume operation. In doing so, the security core's operation may remain uninterrupted. The security core may then record a log indicating that integrity verification has failed. For example, the security core may store in a separate memory in the security core domain 330 (accessible only by the security core) log information needed for analyzing the problem. Then, the security core may copy data from the main memory 314 and/or overwrite certain preset values in the main memory 314. For example, the security core may overwrite the entire region of the main memory 314 or a region related to the tampered data in the main memory 314 with a preset value (e.g., “0”).

In an embodiment, before overwriting the entire region of the main memory 314 with the preset value, the security core may copy the data of regions, excluding the regions associated with the tampered data in the main memory 314, to a predetermined region of a separate memory accessible by the security core. Then, the security core may use an interrupt to notify the host that integrity verification has failed, thereby ending the system protection process. Afterward, the security core may proceed with the recovery process for rebooting the system.

In the recovery process according to an embodiment, the security core may verify the integrity of recovery data. For example, the security core may determine whether trusted recovery data (e.g., firmware, a page table, etc.) stored separately in a nonvolatile memory accessible by the security core, together with an output value (e.g., a hash value) stored in association with the recovery data, has been tampered with. The operation of determining tampering may be performed in the same or a similar way as the integrity verification process described above with reference to FIG. 4. If the security core determines that the recovery data has not been tampered with, the security core may load the recovery data into the main memory 314. For example, the security core may store the recovery data in a region of the main memory 314 different from the region associated with the tampered data, and then reboot the system. The security core may restart operation of the main core.

After the system reboots, the security core may perform integrity verification. For example, the security core may perform the integrity verification process described above with reference to FIG. 4, either on a one-time basis, or periodically, or aperiodically, or for a specified period. If there is no abnormality detected (i.e., if integrity verification succeeds), the recovery process may be terminated. Conversely, if integrity verification fails, the security core may re-execute the system protection process. For instance, if at least some data stored in the main memory 314 is determined to have been tampered with as a result of performing integrity verification, the security core may re-perform the system protection process described above. If it is determined that the recovery data has been tampered with, or if re-execution of the system protection process has been completed, the security core may notify the host that the recovery failed, e.g., using an interrupt. The security core may then wait for a command from the host. If the security core detects an attempt by the host to access the system while waiting for the command from the host, the security core may, assuming that the host might have been subject to a malicious attack, perform authentication for the host's system access. For example, the authentication process may be conducted using the encryption key associated with the host as managed by the encryption key manager 334, and may use a bidirectional cryptographic algorithm (e.g., a symmetric-key cryptography algorithm such as AES or SEED, or an asymmetric-key cryptography algorithm such as RSA or DSA) to ensure confidentiality. In an embodiment, the security core may perform the system protection process first and then perform the recovery process for rebooting the system; alternatively, at least some portion of the system protection process may be performed in parallel with at least some portion of the recovery process.

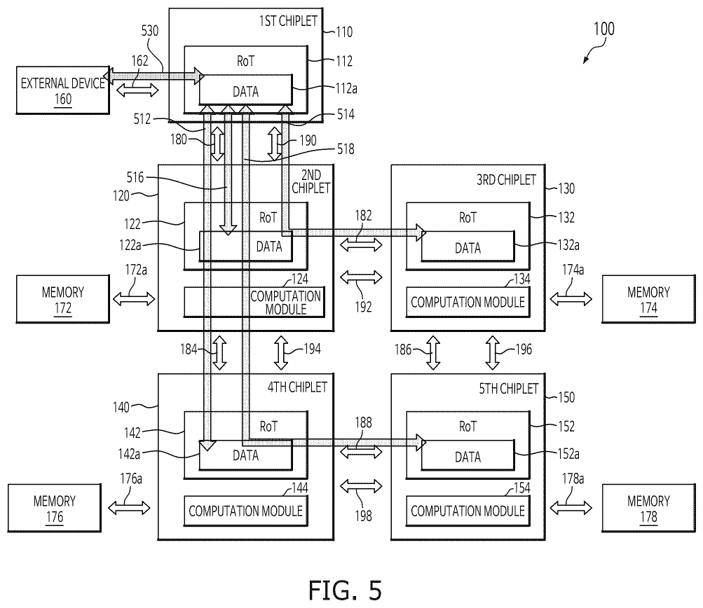

FIG. 5 illustrates a diagram for describing a configuration for the security of the chiplet system 100, which includes the plurality of chiplets 110, 120, 130, 140, 150, according to an embodiment of the present disclosure. Referring to FIG. 5, the chiplet system 100 including the plurality of chiplets 110, 120, 130, 140, 150 may include an I/O chiplet (e.g., the first chiplet 110) in charge of input/output functionality with an external device 160, and a plurality of computation chiplets (e.g., the second chiplet 120, the third chiplet 130, the fourth chiplet 140, and the fifth chiplet 150) in charge of computation functionality. For convenience of description, in what follows, the chiplet in charge of input/output functionality with the external device 160 is referred to as the “I/O chiplet,” and the plurality of chiplets in charge of computation functionality are referred to as “computation chiplets.” The description below refers to the I/O chiplet only as the first chiplet and the other chiplets as computation chiplets, but the present disclosure is not limited thereto. In a chiplet system according to embodiments of the present disclosure, computation chiplets may be replaced by other chiplets that perform memory expansion or other functionality, or such other chiplets may be further included in the system.

The I/O chiplet may include an interface (e.g., interface 162) for communication with the external device 160 and an RoT (e.g., RoT 112) in which tamper-proof data (e.g., data 112a) is stored.

Each computation chiplet may include an interface (e.g., interface 172a, 174a, 176a, 178a) for communication with a memory (e.g., memory 172, 174, 176, 178), an RoT (e.g., RoT 122, 132, 142, 152) in which tamper-proof data (e.g., data 122a, 132a, 142a, 152a) is stored, and a computation module (e.g., computation module 124, 134, 144, 154) that performs computations using data stored in the memory.

The I/O chiplet can obtain, through an interface (e.g., interfaces 180, 182, 184, 186, 188) for communication among the chiplets, information on the security state of a computation chiplet. For example, as in step 512, the I/O chiplet may obtain, via the interface 180 for communication between the I/O chiplet and an adjacent first computation chiplet (e.g., the second chiplet 120), information on the security state of the first computation chiplet based on tamper-proof data (e.g., data 122a). In another example, as in steps 514 and 516, the I/O chiplet may obtain, via the interface 182 or the interface 184 for communication between the first computation chiplet and a second computation chiplet (e.g., the third chiplet 130 or the fourth chiplet 140) adjacent to the first computation chiplet, information on the security state of the second computation chiplet based on tamper-proof data (e.g., data 132a or data 142a) from the second computation chiplet. In that case, information on the security state of the second computation chiplet may be delivered to the I/O chiplet through the interface 182 or 184 for communication between the first computation chiplet and the second computation chiplet and the interface 180 for communication between the I/O chiplet and the first computation chiplet. In another example, as in step 518, the I/O chiplet may obtain, via the interface 188 for communication between the second computation chiplet and a third computation chiplet (e.g., the fifth chiplet 150), information on the security state of the third computation chiplet based on tamper-proof data (e.g., data 152a). In that case, the information on the security state of the third computation chiplet may be delivered to the I/O chiplet through the interface 188 (between the second computation chiplet and the third computation chiplet), the interface 184 or 182 (between the first computation chiplet and the second computation chiplet), and the interface 180 (between the I/O chiplet and the first computation chiplet).

The I/O chiplet may then generate, based on information on the security state of the I/O chiplet (based on tamper-proof data, e.g., data 112a) and information on the security state of the computation chiplets (obtained from each computation chiplet), monitoring information. Then, as in step 530, the I/O chiplet may transmit the generated monitoring information to the external device 160 via the interface (e.g., interface 162) for communication with the external device 160. For example, the I/O chiplet may monitor the overall security state of the chiplet system 100 and report the results to a host device.

Stated differently, the RoT of the I/O chiplet can serve as a primary RoT in the entire chiplet system 100. For example, the primary RoT may monitor the security state of the entire chiplet system 100 and report the results to the host. To do so, the primary RoT may communicate with RoTs distributed among the other chiplets (e.g., the computation chiplets)—these RoTs are secondary RoTs—and thereby obtain information on the security state of each chiplet, then combine that information with the security state information of the I/O chiplet itself to generate monitoring information and transmit it to the host. Since the overall security state of the entire chiplet system 100 is monitored and reported by the I/O chiplet, the chiplet system 100 can be recognized externally (e.g., from a server or data center) as a single device, and the host's RoT may manage the security of the entire system by communicating with the primary RoT of that device. The process by which the host RoT verifies the trustworthiness of a device may be called “attestation.” Further, communications between the host RoT and the device RoT (e.g., the primary RoT) may be based on the SPDM (Security Protocol and Data Model) protocol. Here, the primary RoT of the I/O chiplet may be in charge of security for data-in-transit to and from the host, e.g., controlling integrity and data encryption (IDE) functionality for PCIe TLP (transaction layer packet) security. Meanwhile, the secondary RoTs of the computation chiplets may be in charge of security for data used in computations (e.g., AI computations).

In an embodiment, the information on the security state of a chiplet (e.g., the first chiplet 110, the second chiplet 120, the third chiplet 130, the fourth chiplet 140, and the fifth chiplet 150) may include at least one of information on integrity verification of firmware (e.g., boot firmware) operating in that chiplet or information on real-time integrity verification of at least a portion of data used in that chiplet.

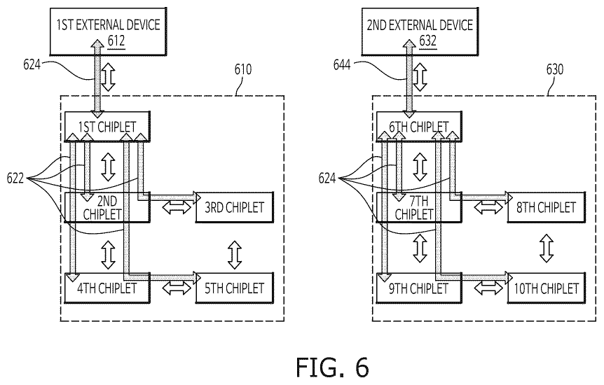

FIG. 6 illustrates a diagram for describing a configuration for the security of a plurality of sub-chiplet systems 610, 630 according to an embodiment of the present disclosure. Referring to FIG. 6, the chiplet system 100 may include a plurality of sub-chiplet systems 610, 630. For example, the chiplet system 100 may include a first sub-chiplet system 610 and a second sub-chiplet system 630. However, the number of sub-chiplet systems included in the chiplet system 100 is not limited thereto. In various embodiments, the chiplet system 100 may also include at least one other sub-chiplet system. Additionally, in FIG. 6, the first sub-chiplet system 610 is depicted as including a first, second, third, fourth, and fifth chiplet, and the second sub-chiplet system 630 is depicted as including a sixth, seventh, eighth, ninth, and tenth chiplet. However, the number of chiplets included in each sub-chiplet system is not limited thereto, and at least one chiplet may be omitted or at least one other chiplet may be further included. In the following description, chiplets other than I/O chiplets are described as computation chiplets, but they are not limited thereto. In a chiplet system according to embodiments of the present disclosure, a computation chiplet may be replaced with another chiplet that performs a memory expansion function or similar functions, or an additional chiplet having such functionality may be further included in the chiplet system.

In FIG. 6, the I/O chiplet of each sub-chiplet system (e.g., the first chiplet of the first sub-chiplet system 610, and the sixth chiplet of the second sub-chiplet system 630) is shown communicating respectively with an external device (e.g., a first external device 612 and a second external device 632). For example, as in step 622, the I/O chiplet (e.g., the first chiplet) of the first sub-chiplet system 610 may obtain from the computation chiplets (e.g., the second, third, fourth, and fifth chiplets) information on the security state of those computation chiplets. Also, as in step 642, the I/O chiplet (e.g., the sixth chiplet) of the second sub-chiplet system 630 may obtain from the computation chiplets (e.g., the seventh, eighth, ninth, and tenth chiplets) information on the security state of those computation chiplets. Then, as in step 624, the I/O chiplet of the first sub-chiplet system 610 may transmit to the first external device 612 monitoring information generated based on the security state of the I/O chiplet and the security state of the computation chiplets obtained from the computation chiplets of the first sub-chiplet system 610. And, as in step 644, the I/O chiplet of the second sub-chiplet system 630 may transmit to the second external device 632 monitoring information generated based on the security state of the I/O chiplet and the security state of the computation chiplets obtained from the computation chiplets of the second sub-chiplet system 630. In this manner, in a structure where each I/O chiplet of the plurality of sub-chiplet systems is connected to a separate host (e.g., the first external device 612 and the second external device 632), the RoT of each I/O chiplet may become the primary RoT that can report the security state of each sub-chiplet system to the host RoT, and thus each sub-chiplet system can be managed for security individually.

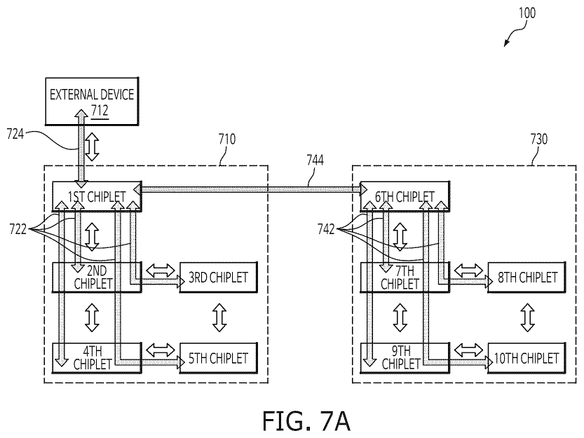

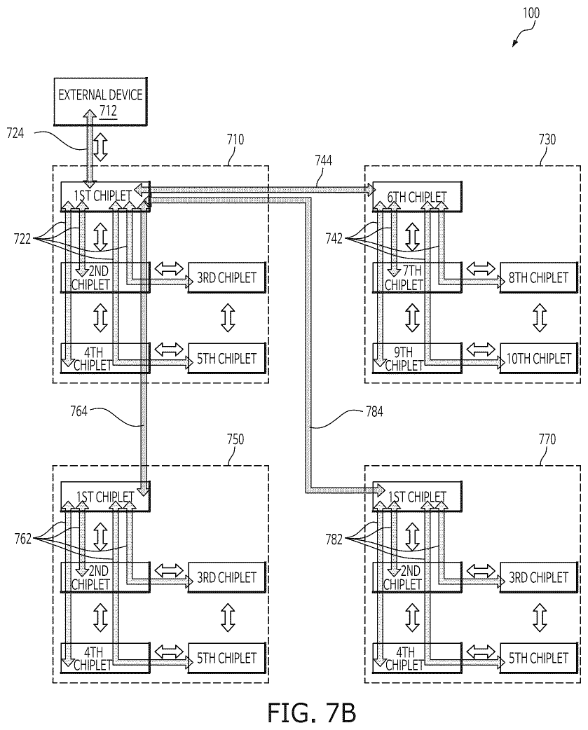

FIG. 7A illustrates another configuration for security of a plurality of sub-chiplet systems 710, 730 according to an embodiment of the present disclosure. Referring to FIG. 7A, the chiplet system 100 may include a plurality of sub-chiplet systems 710, 730. For example, the chiplet system 100 may include a first sub-chiplet system 710 and a second sub-chiplet system 730. However, the number of sub-chiplet systems included in the chiplet system 100 is not limited thereto. In various embodiments, the chiplet system 100 may further include at least one other sub-chiplet system, as shown in FIG. 7B. Also, in FIG. 7A, the first sub-chiplet system 710 is depicted as including a first, second, third, fourth, and fifth chiplet, and the second sub-chiplet system 730 is depicted as including a sixth, seventh, eighth, ninth, and tenth chiplet. However, the number of chiplets included in each sub-chiplet system is not limited thereto, and at least one chiplet may be omitted or at least one other chiplet may be further included. In the following description, only the chiplet in each sub-chiplet system that is not an I/O chiplet is referred to as a computation chiplet, but it is not limited thereto. In a chiplet system according to embodiments of the present disclosure, a computation chiplet may be replaced with another chiplet that performs a memory expansion function, etc., or an additional chiplet having such functionality may be further included in the chiplet system.

FIG. 7A illustrates the structure where a plurality of sub-chiplet systems (e.g., 710 and 730) are interconnected, and one of the sub-chiplet systems (e.g., the first sub-chiplet system 710) includes an I/O chiplet (e.g., the first chiplet) that communicates with an external device 712. For example, as in step 722, the I/O chiplet (e.g., the first chiplet) of the first sub-chiplet system 710 may obtain from its computation chiplets (e.g., the second, third, fourth, and fifth chiplets) information on their security state. Also, as in step 742, the I/O chiplet (e.g., the sixth chiplet) of the second sub-chiplet system 730 may obtain from its computation chiplets (e.g., the seventh, eighth, ninth, and tenth chiplets) information on their security state. Then, as in step 744, the I/O chiplet of the second sub-chiplet system 730 may transmit first monitoring information—generated based on its own security state information and the security state information obtained from its computation chiplets—to the I/O chiplet of the first sub-chiplet system 710. Next, as in step 724, the I/O chiplet of the first sub-chiplet system 710 may generate, based on its own security state information, the security state information obtained from its computation chiplets, and the first monitoring information obtained from the second sub-chiplet system 730, second monitoring information, and transmit that second monitoring information to the external device 712. In other words, in a structure where all I/O chiplets are interconnected (e.g., via Ethernet) and only one I/O chiplet is connected to the host (the external device 712), the RoT of the I/O chiplet connected to the host may act as the primary RoT, the RoT of the other I/O chiplet may act as a secondary RoT, and the RoT of each computation chiplet may act as a tertiary RoT. Each I/O chiplet's RoT may monitor the security states of the RoTs of the computation chiplets. The secondary RoT may report the security state of the second sub-chiplet system 730 to the primary RoT, and the primary RoT may ultimately report the overall security state of the entire chiplet system 100 to the host RoT.

FIG. 7B illustrates yet another configuration for security of a plurality of sub-chiplet systems according to an embodiment of the present disclosure. The chiplet system 100 shown in FIG. 7B may be an expanded structure of the chiplet system 100 shown in FIG. 7A. Therefore, to avoid redundancy, the same or similar configurations described with reference to FIG. 7A will not be repeated here.

Referring to FIG. 7B, the chiplet system 100 may include a plurality of sub-chiplet systems 710, 730, 750, 770. For example, the chiplet system 100 may include a first sub-chiplet system 710, a second sub-chiplet system 730, a third sub-chiplet system 750, and a fourth sub-chiplet system 770. Each I/O chiplet of the plurality of sub-chiplet systems 710, 730, 750, 770 (e.g., the first chiplet in each) may obtain information on the security state of other chiplets (e.g., computation chiplets) included in the same sub-chiplet system, as shown in steps 722, 742, 762, and 782. Then, the I/O chiplets of the sub-chiplet systems not connected to the external device (e.g., the I/O chiplets of the second sub-chiplet system 730, the third sub-chiplet system 750, and the fourth sub-chiplet system 770) may transmit to the I/O chiplet of the first sub-chiplet system 710 the security state information of their respective sub-chiplet systems (as in steps 744, 764, 784). The security state information of a sub-chiplet system may be referred to as “monitoring information” of that sub-chiplet system and may include information on the security state of that sub-chiplet system's I/O chiplet as well as information on the security state of the computation chiplets obtained from those computation chiplets. For example, the I/O chiplet of the first sub-chiplet system 710 may obtain each sub-chiplet system's monitoring information from the other sub-chiplet systems'I/O chiplets. Then, as in step 724, the I/O chiplet of the first sub-chiplet system 710 may transmit to the external device 712 the overall system's monitoring information, which is generated based on the security state of the I/O chiplet of the first sub-chiplet system 710, the security state of the computation chiplets of the first sub-chiplet system 710, and the monitoring information of the other sub-chiplet systems.

As described above, where all of the I/O chiplets included in each sub-chiplet system are connected to each other (e.g., via Ethernet), and only one sub-chiplet system (e.g., the first sub-chiplet system 710) is connected to the host (e.g., the external device 712), the RoT of the I/O chiplet connected to the host may become the primary RoT, the RoTs of the I/O chiplets not connected to the host may become secondary RoTs, and the RoTs of the other chiplets (e.g., computation chiplets) included in each sub-chiplet system may become tertiary RoTs. In such a case, the RoT of each I/O chiplet may monitor the security states of the RoTs of other chiplets, for example, computation chiplets, included in the respective sub-chiplet system. The secondary RoT may report the security state of its sub-chiplet system to the primary RoT, and the primary RoT can ultimately report the overall security state of the entire chiplet system 100 to the host RoT.

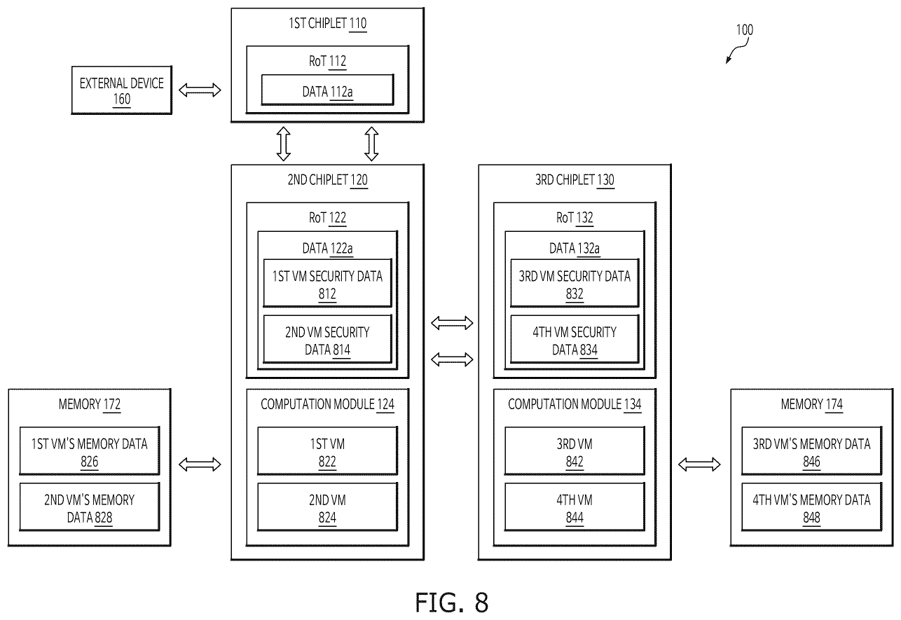

FIG. 8 illustrates a diagram for describing a configuration for resource allocation and data security for a virtual machine according to an embodiment of the present disclosure. Referring to FIG. 8, the chiplet system 100 including the plurality of chiplets 110, 120, 130 may comprise an I/O chiplet (e.g., the first chiplet 110) in charge of input/output functionality with an external device 160, and a plurality of chiplets (e.g., the second chiplet 120 and the third chiplet 130) in charge of computation functionality. Although FIG. 8 shows that the second chiplet 120 and the third chiplet 130 act as computation chiplets, the number of computation chiplets included in the chiplet system 100 is not limited thereto. Various embodiments may omit one of the above-mentioned computation chiplets or further include at least one other computation chiplet (e.g., a fourth chiplet 140 or a fifth chiplet 150). Furthermore, in FIG. 8, configurations similar to those described with reference to FIG. 1 through 7B for the chiplet system 100 are not repeated. In the following description, a chiplet other than the I/O chiplet is referred to as a computation chiplet, but the present disclosure is not limited thereto. In the chiplet system including a plurality of chiplets according to embodiments of the present disclosure, a computation chiplet may be replaced with another chiplet that provides memory expansion or other functionalities, or an additional chiplet having such functionality may be further included in the chiplet system.

FIG. 8 illustrates, among the configurations for resource allocation and data security for a virtual machine (VM), a configuration in which a computation resource that processes computations associated with each of a plurality of VMs and a memory resource that stores data of those computations are allocated to corresponding chiplets and memories. This structure may be referred to as an “intra-chiplet data security” configuration.

In an intra-chiplet data security architecture, the computation resource that processes computation associated with each VM and the memory resource that stores data of that computation may be allocated to a corresponding chiplet and memory. For example, if the computation resource associated with the first VM 822 is allocated to the computation module 124 of the second chiplet 120, then the memory resource that stores data of the computation associated with the first VM 826 may be allocated to the memory 172 that communicates with the second chiplet 120. Similarly, if the computation resource associated with the second VM 824 is allocated to the computation module 124 of the second chiplet 120, the memory resource that stores data of the computation associated with the second VM 828 may be allocated to the memory 172 that communicates with the second chiplet 120. Further, if the computation resource associated with the third VM 842 is allocated to the computation module 134 of the third chiplet 130, the memory resource that stores data of the computation associated with the third VM 846 may be allocated to the memory 174 that communicates with the third chiplet 130. Also, if the computation resource associated with the fourth VM 844 is allocated to the computation module 134 of the third chiplet 130, the memory resource that stores data of the computation associated with the fourth VM 848 may be allocated to the memory 174 that communicates with the third chiplet 130. In that scenario, tamper-proof data may be stored in the RoT of each chiplet to which a VM's resource is allocated. For example, the RoT 122 of the second chiplet 120 may store (or have allocated) first VM security data 812 (tamper-proof data for securing the first VM's data) and second VM security data 814 (tamper-proof data for securing the second VM's data), and the RoT 132 of the third chiplet 130 may store (or have allocated) third VM security data 832 (tamper-proof data for securing the third VM's data) and fourth VM security data 834 (tamper-proof data for securing the fourth VM's data). Thus, in the intra-chiplet data security architecture, if a VM uses both the computation resource and the memory resource within the same chiplet, the RoT of the chiplet allocated to that VM can manage the data security for that VM by granting different encryption keys to each VM so that the data stored in the memory is not exposed to a different VM.

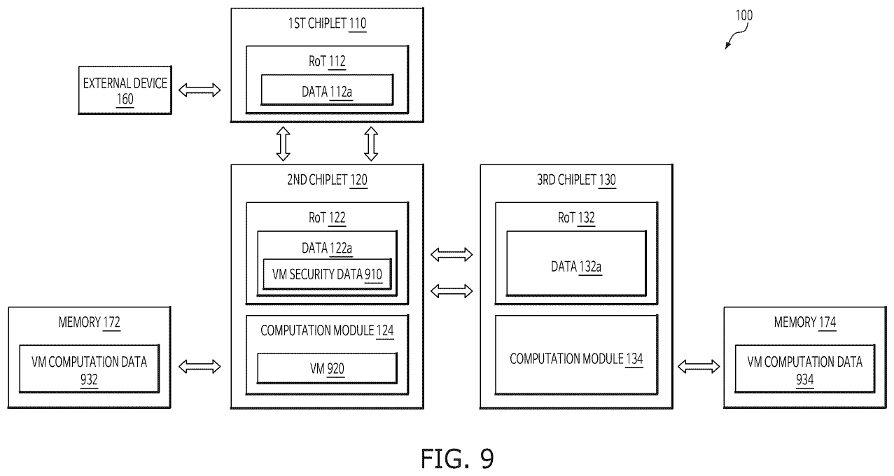

FIG. 9 is a diagram for explaining another configuration for resource allocation and data security for a virtual machine according to an embodiment of the present disclosure. Referring to FIG. 9, the chiplet system 100 including the plurality of chiplets 110, 120, 130 may comprise an I/O chiplet (e.g., the first chiplet 110) in charge of I/O functionality with the external device 160, and a plurality of chiplets (e.g., the second chiplet 120 and the third chiplet 130) in charge of computation functionality. Although FIG. 9 shows the second chiplet 120 and the third chiplet 130 as computation chiplets, the number of computation chiplets in the chiplet system 100 is not limited thereto. Various embodiments of the chiplet system may omit one of the computation chiplets or further include at least one other computation chiplet (e.g., the fourth chiplet 140 or the fifth chiplet 150). Also, in FIG. 9, configurations similar to those described with reference to FIGS. 1 through 7B for the chiplet system 100 are not repeated. In the following description, a chiplet other than the I/O chiplet is referred to as a computation chiplet, but the present disclosure is not limited thereto. In the chiplet system having a plurality of chiplets according to embodiments of the present disclosure, a computation chiplet may be replaced with another chiplet that provides memory expansion functionality or the like, or an additional chiplet having such functionality may be further included in the chiplet system.

FIG. 9 illustrates an “inter-chiplet data security” configuration in which either the computation resource that processes the VM's computation or the memory resource that stores the data of that computation (or both) is allocated in a distributed manner across multiple chiplets or memories. More specifically, FIG. 9 shows the case of inter-chiplet data security in which the memory resource is distributed across multiple memories.

In an inter-chiplet data security architecture where the memory resource is distributed and allocated across multiple memories, the computation resource that processes the VM's computation may be allocated to one chiplet, while the memory resource that stores the data of that computation may be distributed across multiple memories associated with multiple chiplets. For example, the computation resource for a VM 920 may be allocated to the computation module 124 of the second chiplet 120, while the memory resource for that VM computation data 932, 934 may be distributed to both the memory 172 associated with the second chiplet 120 and the memory 174 associated with the different third chiplet 130. That is, a portion 932 of the VM computation data 932, 934 may be allocated to the memory 172 communicating with the second chiplet 120, while another portion 934 of the VM computation data may be allocated to the memory 174 communicating with the third chiplet 130. In that scenario, tamper-proof data responsible for securing that VM's data may be stored in the RoT of the chiplet to which the VM's resource is allocated. For example, the RoT 122 of the second chiplet 120 may store (or have allocated) VM security data 910, which manages security for that VM's data. For example, the VM 920 may utilize the computing module 124 of the second chiplet 120, however, due to the large data size, the VM may use memory resources not only from the second chiplet 120 but also from the third chiplet 130. In this case, the RoT 122 of the second chiplet 120 is responsible for ensuring the data security of the corresponding VM and may manage the encryption keys. The other chiplet's RoT (e.g., the RoT of the third chiplet 130) has no authority over that encryption key, so the other chiplet cannot view the VM's data (which is encrypted) that resides in its memory. Moreover, since the data is transferred over the chiplet-to-chiplet interface in an encrypted form, there is no risk of data exposure.

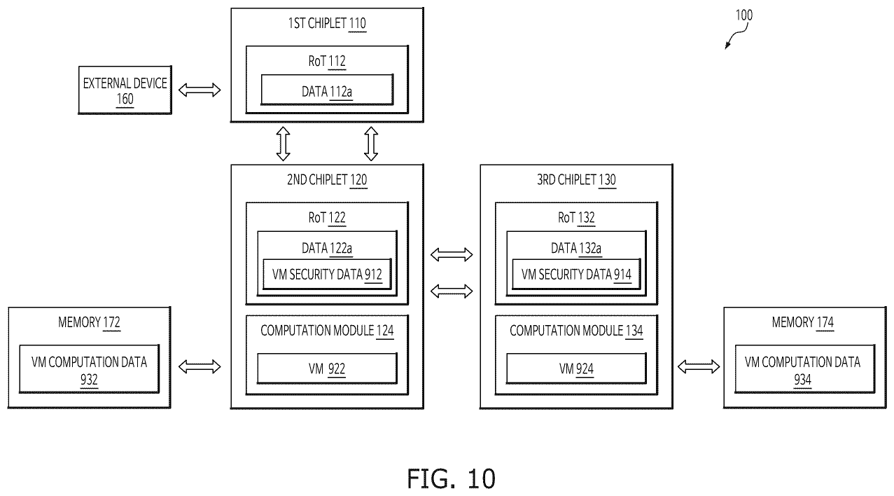

FIG. 10 illustrates yet another configuration for resource allocation and data security for a virtual machine according to an embodiment of the present disclosure. Referring to FIG. 10, the chiplet system 100 including the plurality of chiplets 110, 120, 130 may comprise an I/O chiplet (e.g., the first chiplet 110) in charge of I/O functionality with the external device 160, and a plurality of chiplets (e.g., the second chiplet 120 and the third chiplet 130) in charge of computation functionality. Although FIG. 10 shows the second chiplet 120 and the third chiplet 130 as computation chiplets, the number of computation chiplets in the chiplet system 100 is not limited thereto. Various embodiments may omit one computation chiplet or may further include at least one other computation chiplet (e.g., the fourth chiplet 140 or the fifth chiplet 150). Also, in FIG. 10, configurations similar to those described with reference to FIGS. 1 through 7B for the chiplet system 100 are not repeated. In the following description, a chiplet other than the I/O chiplet is referred to as a computation chiplet, but the present disclosure is not limited thereto. In the chiplet system that includes a plurality of chiplets according to embodiments of the present disclosure, a computation chiplet may be replaced with a chiplet providing memory expansion or other functionality, or an additional chiplet having such functionality may be further included in the chiplet system.

In FIG. 10, it is described that, for resource allocation and data security of a VM configuration, either the computation resources that process computations associated with any one VM or the memory resources that store data of computations associated with the corresponding VM are distributedly allocated across multiple chiplets or memories. This structure can be referred to as an inter-chiplet data security architecture. Particularly, FIG. 10 describes the structure in which the computation resources and memory resources are distributedly allocated across multiple chiplets and memories in an inter-chiplet data security architecture.

In an inter-chiplet data security architecture where the computation resource and memory resource are both distributed across multiple chiplets and memories, the computation resource associated with a VM may be distributed across multiple chiplets, and the memory resource that stores data of that VM's computation may also be distributed across memories associated with multiple chiplets. For example, the computation resource for a VM 922, 924 may be distributed across both the computation module 124 of the second chiplet 120 and the computation module 134 of the third chiplet 130, and the memory resource for that VM computation data 932, 934 may also be distributed across both the memory 172 that communicates with the second chiplet 120 and the memory 174 that communicates with the third chiplet 130. In this case, tamper-proof data for securing that VM's data may be stored in the RoTs of the chiplets to which the VM's resources are allocated. For example, the RoT 122 of the second chiplet 120 may store VM security data 912, which is main security data responsible for generating and granting encryption keys for that VM's data. The RoT 132 of the third chiplet 130 may store VM security data 914, which is subordinate security data that receives the shared encryption key from the main security data 912 and performs security processing on the data stored in the memory 174 communicating with the third chiplet 130. Here, the VM security data 912 that may be in charge of the VM's data security and generate and grant the encryption key to the VM may be referred to as main security data, and the VM security data 914 that receives the encryption key from the main security data and performs security processing on the data stored in the associated memory may be referred to as sub-security data. In this manner, in an inter-chiplet data security architecture in which both the computation resource and the memory resource are distributed across multiple chiplets and multiple memories, a single chiplet (e.g., the second chiplet 120) can still generate and manage the encryption key used for that VM. Then, to enable the other chiplet (e.g., the third chiplet 130) to perform computations (e.g., AI computations) by decrypting the VM's encrypted data, the RoT of the chiplet that generates and manages the encryption key (e.g., the second chiplet 120) may share that VM's encryption key with the RoT of the other chiplet (e.g., the third chiplet 130) via a general key-exchange method (e.g., Diffie-Hellman key exchange). The RoT of that other chiplet can thus manage the encryption key for the portion of the VM's data stored in its own memory and handle the VM's sub-security.

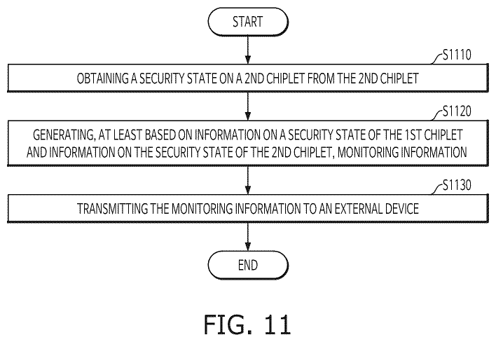

FIG. 11 illustrates a diagram for describing a security method for a chiplet system including a plurality of chiplets according to an embodiment of the present disclosure. Referring to FIG. 11, in a chiplet system (e.g., the chiplet system 100) including a plurality of chiplets (e.g., the first chiplet 110, the second chiplet 120, the third chiplet 130, the fourth chiplet 140, and the fifth chiplet 150), the first chiplet (or the I/O chiplet) may, at step S1110, obtain from the second chiplet (or a computation chiplet) information on the security state of the second chiplet. Here, the first chiplet may be the I/O chiplet that includes a first interface (e.g., interface 162) for communication with an external device (e.g., a host device) and a first RoT (e.g., RoT 112) in which tamper-resistant first data (e.g., data 112a) is stored. The second chiplet may be the computation chiplet that includes a second interface (e.g., interface 172a) for communication with a memory (e.g., memory 172), a second RoT (e.g., RoT 122) in which tamper-resistant second data (e.g., data 122a) is stored, and a computation module (e.g., computation module 124) that performs computations using data stored in the memory (e.g., memory 172). For example, the I/O chiplet (or the first chiplet) may obtain from the computation chiplet (e.g., the second chiplet 120), via an interface for communication between the I/O chiplet and the computation chiplet, information on the computation chiplet's security state based on tamper-proof data. In the following description, the chiplet other than the I/O chiplet is referred to as the computation chiplet, but the present disclosure is not limited thereto. In a chiplet system including a plurality of chiplets according to embodiments of the present disclosure, the computation chiplet may be replaced with another chiplet that provides memory expansion or other functionality, or an additional chiplet having such functionality may be further included in the chiplet system.

At step S1120, the first chiplet (or the I/O chiplet) may generate, at least based on information on the security state of the first chiplet and information on the security state of the second chiplet(or computation chiplet), monitoring information. For example, the I/O chiplet may generate, based on information on the security state of the I/O chiplet (based on tamper-proof data, e.g., data 112a) and information on the security state of the computation chiplet obtained from the computation chiplet, the monitoring information.

At step S1130, the first chiplet (or the I/O chiplet) may transmit the monitoring information to the external device (e.g., the external device 160). For example, the I/O chiplet may report the monitoring information on the entire chiplet system to the external device via the interface (e.g., interface 162) for communication with the external device.

In describing the security method for a chiplet system with reference to FIG. 11, it was assumed that the chiplet system includes only one computation chiplet (e.g., the second chiplet 120). However, the number of computation chiplets is not so limited. In various embodiments, the chiplet system may include a plurality of computation chiplets. For example, the chiplet system may further include at least one among the third chiplet (e.g., the third chiplet 130), the fourth chiplet (e.g., the fourth chiplet 140), or the fifth chiplet (e.g., the fifth chiplet 150) as additional computation chiplets. The plurality of computation chiplets may include, for example, a first computation chiplet adjacent to the I/O chiplet (e.g., the second chiplet 120), a second computation chiplet adjacent to the first computation chiplet (e.g., the third chiplet 130 and the fourth chiplet 140), and a third computation chiplet adjacent to the second computation chiplet (e.g., the fifth chiplet 150). The second computation chiplet may include an interface (e.g., interface 174a, 176a) for communication with a memory (e.g., memory 174, 176), a RoT (e.g., RoT 132, 142) in which tamper-proof data (e.g., data 132a, 142a) is stored, and a computation module (e.g., computation module 134, 144) that performs computations using the data stored in that memory. The third computation chiplet may include an interface (e.g., interface 178a) for communication with a memory (e.g., memory 178), a RoT (e.g., RoT 152) in which tamper-proof data (e.g., data 152a) is stored, and a computation module (e.g., computation module 154) that performs computations using data stored in that memory.

If the chiplet system includes a second computation chiplet in addition to the first computation chiplet, the I/O chiplet may obtain, from the second computation chiplet, information on the security state of the second computation chiplet based on tamper-proof data. In that case, the information on the security state of the second computation chiplet may be delivered to the I/O chiplet via the interface (e.g., 182 or 184) for communication between the first computation chiplet and the second computation chiplet and the interface (e.g., 180) for communication between the I/O chiplet and the first computation chiplet. The I/O chiplet may then generate, based on the security state of the I/O chiplet, the security state of the first computation chiplet obtained from the first computation chiplet, and the security state of the second computation chiplet obtained from the second computation chiplet, monitoring information, and transmit the monitoring information to the external device.

If the chiplet system includes a third computation chiplet in addition to the first and second computation chiplets, the I/O chiplet may also obtain, from the third computation chiplet, information on the security state of the third computation chiplet based on tamper-proof data. In that case, the information on the security state of the third computation chiplet may be delivered to the I/O chiplet via the interface (e.g., interface 186 or 188) for communication between the second computation chiplet and the third computation chiplet, the interface (e.g., interface 182 or 184) for communication between the first computation chiplet and the second computation chiplet, and the interface (e.g., interface 180) for communication between the I/O chiplet and the first computation chiplet. The I/O chiplet may then generate, based on the security state of the I/O chiplet, the security state of the first computation chiplet obtained from the first computation chiplet, the security state of the second computation chiplet obtained from the second computation chiplet, and the security state of the third computation chiplet obtained from the third computation chiplet, monitoring information, and transmit this monitoring information to the external device.

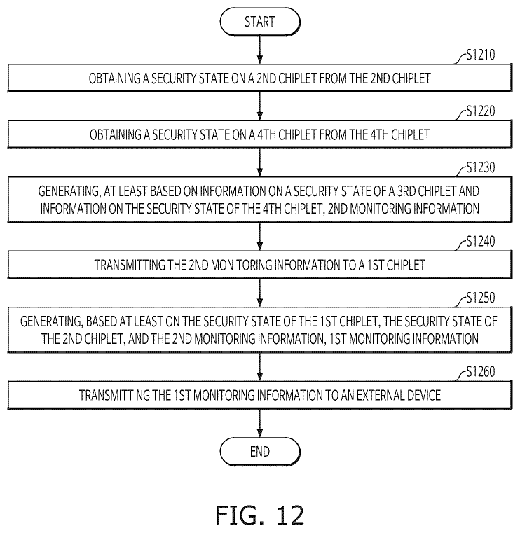

FIG. 12 illustrates a diagram for describing a security method for a plurality of chiplet systems according to an embodiment of the present disclosure. Referring to FIG. 12, in a chiplet system (e.g., the chiplet system 100) that includes a plurality of sub-chiplet systems (e.g., a first sub-chiplet system 710 and a second sub-chiplet system 730), a first chiplet (or the I/O chiplet of the first sub-chiplet system) may, at step S1210, obtain from a second chiplet (or the computation chiplet of the first sub-chiplet system) information on the security state of that second chiplet. For example, the I/O chiplet of the first sub-chiplet system may obtain, via an interface for communication between the I/O chiplet and the computation chiplet, information on the security state of the computation chiplet in the first sub-chiplet system based on tamper-proof data. In the following description, a chiplet other than the I/O chiplet is referred to as a computation chiplet, but the present disclosure is not limited thereto. In a chiplet system that includes a plurality of chiplets according to embodiments of the present disclosure, a computation chiplet may be replaced with another chiplet that provides memory expansion or other functionality, or an additional chiplet having such functionality may be further included in the chiplet system.

At step S1220, a third chiplet (or the I/O chiplet of the second sub-chiplet system) in the chiplet system may obtain, from a fourth chiplet (or a computation chiplet in the second sub-chiplet system), information on the security state of the fourth chiplet. For example, the I/O chiplet of the second sub-chiplet system may obtain from the computation chiplet in the second sub-chiplet system, via an interface for communication between the I/O chiplet and the computation chiplet, information on the security state of the computation chiplet based on tamper-proof data.

At step S1230, the third chiplet (or the I/O chiplet of the second sub-chiplet system) may generate, based at least on the security state of the third chiplet and the security state of the fourth chiplet, second monitoring information. For example, the I/O chiplet of the second sub-chiplet system may generate, based on information on the security state of the I/O chiplet of the second sub-chiplet system (based on tamper-proof data) and information on the security state of the computation chiplet of the second sub-chiplet system, obtained from the computation chiplet of the second sub-chiplet system, monitoring information (i.e., second monitoring information) on the second sub-chiplet system.

At step S1240, the third chiplet (or the I/O chiplet of the second sub-chiplet system) may transmit the second monitoring information to the first chiplet (or the I/O chiplet of the first sub-chiplet system). For example, the I/O chiplet of the second sub-chiplet system may transmit, via an interface between I/O chiplets (e.g., Ethernet), the second monitoring information on the security state of the second sub-chiplet system to the I/O chiplet of the first sub-chiplet system.

At step S1250, the first chiplet (or the I/O chiplet of the first sub-chiplet system) may generate, based at least on the security state of the first chiplet, the security state of the second chiplet, and the second monitoring information, first monitoring information. For example, the I/O chiplet of the first sub-chiplet system may generate, based on the security state of the I/O chiplet of the first sub-chiplet system (based on tamper-proof data), first monitoring information on the overall security state of the chiplet system, the security state of the computation chiplet of the first sub-chiplet system (obtained from the computation chiplet), and the second monitoring information on the security state of the second sub-chiplet system (obtained from the I/O chiplet of the second sub-chiplet system).

At step S1260, the first chiplet (or the I/O chiplet of the first sub-chiplet system) may transmit the first monitoring information to an external device (e.g., the external device 160). For example, the I/O chiplet of the first sub-chiplet system may transmit the first monitoring information, representing the overall security state of the entire chiplet system, to a host device.

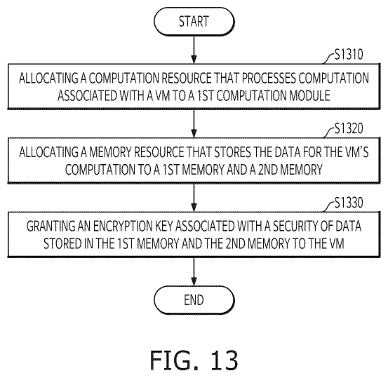

FIG. 13 illustrates a diagram describing a method for resource allocation and data security for a virtual machine according to an embodiment of the present disclosure. Referring to FIG. 13, the method applies to an inter-chiplet data security architecture in which the memory resource is distributed across multiple memories. In a chiplet system 100 that includes a plurality of chiplets (e.g., the first chiplet 110, the second chiplet 120, the third chiplet 130, the fourth chiplet 140, and the fifth chiplet 150), at step S1310, the first chiplet (or I/O chiplet) may allocate a computation resource that processes computation associated with a VM to a first computation module (e.g., the computation module 124 of the second chiplet 120). For example, in response to receiving a request associated with resource allocation for a VM, the I/O chiplet may allocate a computation resource that processes computation associated with that VM to the computation module of the first computation chiplet. In the following description, any chiplet other than the I/O chiplet is described as a computation chiplet, but the present disclosure is not limited thereto. In the chiplet system including a plurality of chiplets according to embodiments of the present disclosure, the computation chiplet may be replaced with another chiplet that provides memory expansion or other functionality, or an additional chiplet having such functionality may be further included in the chiplet system.

At step S1320, the first chiplet (or I/O chiplet) may allocate a memory resource that stores the data for the VM's computation to a first memory (e.g., memory 172) and a second memory (e.g., memory 174). For example, the I/O chiplet may distribute the memory resource that stores the VM computation data between the memory 172 (which communicates with the first computation chiplet, e.g., the second chiplet 120) and the memory 174 (which communicates with another chiplet, e.g., the third chiplet 130).

At step S1330, the second chiplet (or the first computation chiplet) may grant an encryption key associated with the security of data stored in the first memory and the second memory to the VM. For example, the first computation chiplet may grant, based on tamper-proof data (e.g., data 122a), to the VM the encryption key related to securing data stored in the first memory (e.g., memory 172) and the second memory (e.g., memory 174).

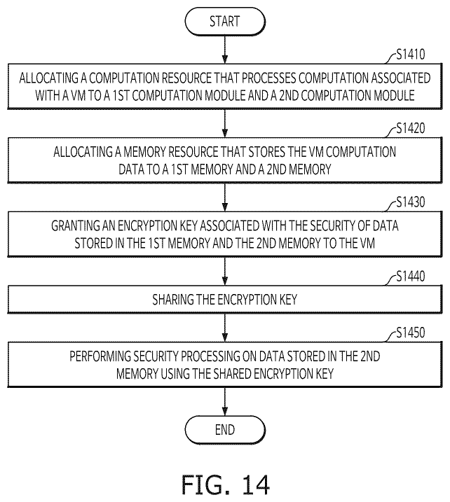

FIG. 14 illustrates another method for resource allocation and data security for a virtual machine according to an embodiment of the present disclosure. Referring to FIG. 14, the method applies to an inter-chiplet data security architecture in which both the computation resource and the memory resource are distributed across multiple chiplets and multiple memories. In a chiplet system 100 that includes a plurality of chiplets (e.g., the first chiplet 110, the second chiplet 120, the third chiplet 130, the fourth chiplet 140, and the fifth chiplet 150), at step S1410, the first chiplet (or I/O chiplet) may allocate a computation resource that processes computation associated with a VM to a first computation module (e.g., the computation module 124 of the second chiplet 120) and a second computation module (e.g., the computation module 134 of the third chiplet 130). For example, in response to receiving a request associated with resource allocation for a VM, the I/O chiplet may distribute the computation resource that processes the VM's computation between the computation module of the first computation chiplet and the computation module of the second computation chiplet. In the following description, a chiplet other than the I/O chiplet is described as a computation chiplet, but it is not limited thereto. In the chiplet system including a plurality of chiplets, a computation chiplet may be replaced with another chiplet that provides memory expansion or other functionality, or an additional chiplet having such functionality may be further included in the chiplet system.

At step S1420, the first chiplet (or I/O chiplet) of the chiplet system may allocate a memory resource that stores the VM computation data to a first memory (e.g., memory 172) and a second memory (e.g., memory 174). For example, the I/O chiplet may distribute the memory resource that stores the VM computation data between the memory 172 (which communicates with the first computation chiplet, e.g., the second chiplet 120) and the memory 174 (which communicates with the second computation chiplet, e.g., the third chiplet 130).

At step S1430, the second chiplet (or the first computation chiplet) may grant an encryption key associated with the security of data stored in the first memory and the second memory to the VM. For example, the first computation chiplet may grant, based on tamper-resistant second data (e.g., data 122a), to the VM an encryption key associated with security of data stored in the first memory (e.g., memory 172) and the second memory (e.g., memory 174).

At step S1440, the second chiplet (or the first computation chiplet) of the chiplet system may share the encryption key. For example, the first computation chiplet may share the generated encryption key with the second computation chiplet (e.g., the third chiplet 130).

At step S1450, the third chiplet (or the second computation chiplet) of the chiplet system may perform security processing on data stored in the second memory using the shared encryption key. For example, the second computation chiplet may perform security processing on data stored in the second memory (e.g., memory 174) that communicates with the second computation chiplet using the encryption key shared by the first computation chiplet.

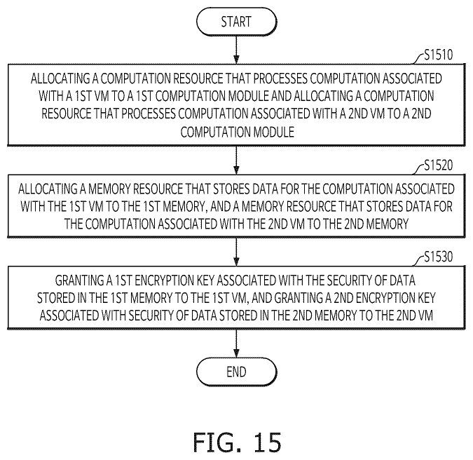

FIG. 15 illustrates a diagram for describing a method for resource allocation and data security for multiple virtual machines according to an embodiment of the present disclosure. Referring to FIG. 15, the method represents a method within the data security structure in a chip. In a chiplet system 100 that includes a plurality of chiplets (e.g., the first chiplet 110, the second chiplet 120, the third chiplet 130, the fourth chiplet 140, and the fifth chiplet 150), at step S1510, the first chiplet (or I/O chiplet) may allocate a computation resource that processes computation associated with a first VM to a first computation module (e.g., the computation module 124 of the second chiplet 120), and allocate a computation resource that processes computation associated with a second VM to a second computation module (e.g., the computation module 134 of the third chiplet 130). For example, in response to receiving a request associated with resource allocation for multiple VMs, the I/O chiplet may allocate the computation resources that process each of the multiple VMs'computations to each of the multiple computation chiplets, respectively. In the following description, a chiplet other than the I/O chiplet is referred to as a computation chiplet, but the present disclosure is not limited thereto. In the chiplet system including a plurality of chiplets, a computation chiplet may be replaced with another chiplet that provides memory expansion or other functionality, or an additional chiplet having such functionality may be further included in the chiplet system.

At step S1520, the first chiplet (or I/O chiplet) may allocate a memory resource that stores data for the computation associated with the first VM to the first memory (e.g., memory 172), and a memory resource that stores data for the computation associated with the second VM to the second memory (e.g., memory 174). For example, the I/O chiplet may allocate the memory resource that stores each VM computation data to the memory that communicates with the respective computation chiplet.

At step S1530, the second chiplet (or the first computation chiplet) may grant a first encryption key associated with security of data stored in the first memory to the first VM, and the third chiplet (or the second computation chiplet) may grant a second encryption key associated with security of data stored in the second memory to the second VM. For example, each computation chiplet to which a different VM is allocated may grant a different encryption key to each VM.

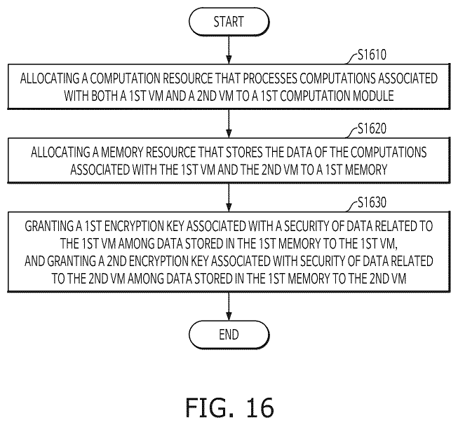

FIG. 16 illustrates another method for resource allocation and data security for multiple virtual machines according to an embodiment of the present disclosure. Referring to FIG. 16, the method applies to an intra-chiplet data security architecture. In a chiplet system 100 that includes a plurality of chiplets (e.g., the first chiplet 110, the second chiplet 120, the third chiplet 130, the fourth chiplet 140, and the fifth chiplet 150), at step S1610, the first chiplet (or I/O chiplet) may allocate a computation resource that processes computations associated with both a first VM and a second VM to a first computation module (e.g., the computation module 124 of the second chiplet 120). For example, in response to receiving a request associated with resource allocation for multiple VMs, the I/O chiplet may allocate the computation resources for each of those VMs to the same computation chiplet. In the following description, a chiplet other than the I/O chiplet is referred to as a computation chiplet, but the present disclosure is not limited thereto. In a chiplet system that includes a plurality of chiplets, a computation chiplet may be replaced with another chiplet that provides memory expansion or other functionality, or an additional chiplet having such functionality may be further included in the chiplet system.

At step S1620, the first chiplet (or I/O chiplet) may allocate a memory resource that stores the data of the computations associated with both the first VM and the second VM to a single first memory (e.g., memory 172). For example, the I/O chiplet may allocate the memory resource that stores data of each VM's computations to a single memory that communicates with the same computation chiplet.

At step S1630, the second chiplet (or the first computation chiplet) may grant a first encryption key associated with security of data related to the first VM among data stored in the first memory to the first VM, and grant a second encryption key associated with security of data related to the second VM among data stored in the first memory to the second VM. For example, where different sets of data stored in the same memory are associated with different VMs, separate encryption keys may be granted to each VM for security of each VM's data.

The above flowcharts and descriptions are merely examples, and some embodiments may be implemented differently. For example, in some embodiments the order of certain steps may be changed, some steps may be repeated, some steps may be omitted, or some steps may be added.

The above methods can be provided as computer programs stored on a computer-readable recording medium, so that a computer can execute them. The medium may store a program for continuous storage or for temporary storage of execution or download. The medium may be any single or multiple hardware apparatus, combined in various ways to provide different recording or storage means, and is not restricted to media directly connected to a particular computer, but can be distributed on a network. Examples of the medium include, but are not limited to, a hard disk, a floppy disk, a magnetic tape, a CD-ROM, a DVD, a floptical disk, a magneto-optical medium, and various storage media that can store program instructions. Additional examples of media include media or storage media managed by application stores or any other sites or servers that distribute or supply software.

Various aspects of the present disclosure may be implemented in various ways, including hardware, firmware, software, or combinations thereof. For example, the logic blocks, modules, circuits, and algorithm steps described herein can be implemented in electronic hardware, computer software, or combinations thereof, as will be understood by those of ordinary skill in the art. To clarify such interchangeability of hardware and software, various illustrative components, blocks, modules, circuits, and steps were generally described in terms of their functionality. Whether such functionality is implemented as hardware or software depends on the particular application and design constraints imposed on the entire system. A person of ordinary skill in the art may implement the described functionality in various ways, but such implementations should not be interpreted as going beyond the scope of the present disclosure.

In a hardware implementation, processing units used to perform the described methods may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in this disclosure, computers, or combinations thereof.

Accordingly, various illustrative logical blocks, modules, and circuits described in connection with this disclosure may be implemented or performed using a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative may be any conventional processor, controller, microcontroller, or state machine. A processor may also be a combination of computing devices, for example, a combination of a DSP and a microprocessor, a combination of multiple microprocessors, one or more microprocessors combined with a DSP core, or any other such configuration.

In a firmware and/or software implementation, the techniques may be implemented as instructions stored on computer-readable media such as random access memory (RAM), read-only memory (ROM), non-volatile random access memory (NVRAM), programmable read-only memory (PROM), erasable programmable read-only memory (EPROM), electrically erasable programmable read-only memory (EEPROM), flash memory, compact discs (CD), magnetic or marking data storage devices, and the like. The instructions may be executed by one or more processors, allowing the processor(s) to perform specific aspects of the functions described in this disclosure.

In software implementations, the described methods may be stored or transmitted as one or more instructions or code on a computer-readable medium. Computer-readable media include both storage media and communication media, including any media that facilitate the transfer of a computer program from one place to another. Storage media may include any available media accessible by a computer. Non-limiting examples of such computer-readable media include RAM, ROM, EEPROM, CD-ROM, or other optical disk storage, magnetic disk storage, or other magnetic storage devices or any other media that can store or transmit desired program code in the form of instructions or data structures, which can be accessed by a computer. Furthermore, any connection is properly referred to as a computer-readable medium.

For example, when software is transmitted from a website, server, or other remote sources using technologies such as coaxial cables, fiber optic cables, twisted pairs, digital subscriber lines (DSL), or wireless technologies such as infrared, wireless, and microwave, these coaxial cables, fiber optic cables, twisted pairs, digital subscriber lines, and wireless technologies like infrared, wireless, and microwave are included within the definition of the medium. Disks and discs as used herein include CDs, laser disks, optical disks, DVDs (digital versatile discs), floppy disks, and Blu-ray discs, where disks usually reproduce data magnetically, whereas discs reproduce data optically using a laser. The above combinations should also fall within the scope of computer-readable media.

The software module may reside within RAM memory, flash memory, ROM memory, EPROM memory, EEPROM memory, registers, hard disk, removable disk, CD-ROM, or any other form of known storage medium. Exemplary storage mediums may be connected to a processor to allow the processor to read information from or write information to the storage medium. Alternatively, the storage medium may be integrated into the processor. The processor and storage medium may be present within an ASIC. The ASIC may be present within a user terminal. Alternatively, the processor and storage medium may exist as individual components in the user terminal.

Accordingly, it should be understood that while some embodiments have been described as being executed on a standalone computer system, the present disclosure is not limited thereto, and it may be implemented in any computing environment, such as a network or distributed computing environment. Furthermore, it may be implemented in multiple processing chips or devices, and storage may likewise be distributed accordingly. Such devices may include PCs, network servers, and portable devices.

Although this specification has described the present disclosure in relation to certain embodiments, various modifications and changes can be made without departing from the scope of the present disclosure as understood by a person of ordinary skill in the art in the technical field to which the invention belongs. Furthermore, such modifications and changes are considered to fall within the scope of the claims appended to this specification.

1. A chiplet system comprising a plurality of chiplets, the chiplet system comprising:
a first chiplet comprising a first interface for communicating with a first external device and a first RoT (root of trust) in which tamper-resistant first data is stored; and
a second chiplet comprising a second interface for communicating with a first memory, a second RoT in which tamper-resistant second data is stored, and a first computation module that performs computation using data stored in the first memory,
wherein the first chiplet is configured to:
obtain, from the second chiplet, through a third interface for communication between the first chiplet and the second chiplet, information on a security state of the second chiplet based on the second data,
generate, based on information on a security state of the first chiplet based on the first data and the information on the security state of the second chiplet obtained from the second chiplet, first monitoring information, and
transmit the first monitoring information to the first external device through the first interface.

2. The chiplet system according to claim 1, further comprising a third chiplet comprising a fourth interface for communicating with a second memory, a third RoT in which tamper-resistant third data is stored, and a second computation module that performs computation using data stored in the second memory,
wherein the first chiplet is further configured to obtain, from the third chiplet, through a fifth interface for communication between the second chiplet and the third chiplet, and the third interface, information on a security state of the third chiplet based on the third data, and
the first monitoring information is generated based on the information on the security state of the first chiplet based on the first data, the information on the security state of the second chiplet obtained from the second chiplet, and the information on the security state of the third chiplet obtained from the third chiplet.

3. The chiplet system according to claim 2, further comprising a fourth chiplet comprising a sixth interface for communicating with a third memory, a fourth RoT in which tamper-resistant fourth data is stored, and a third computation module that performs computation using data stored in the third memory,
wherein the first chiplet is further configured to obtain, from the fourth chiplet, through a seventh interface for communication between the third chiplet and the fourth chiplet, the fifth interface, and the third interface, information on a security state of the fourth chiplet based on the fourth data, and
the first monitoring information is generated based on the information on the security state of the first chiplet based on the first data, the information on the security state of the second chiplet obtained from the second chiplet, the information on the security state of the third chiplet obtained from the third chiplet, and the information on the security state of the fourth chiplet obtained from the fourth chiplet.

4. The chiplet system according to claim 2, wherein the first chiplet is configured to, in response to receiving a request associated with resource allocation for a virtual machine, allocate a computation resource that processes computation associated with the virtual machine to the first computation module while allocating a memory resource that stores data of the computation associated with the virtual machine to the first memory and the second memory, and
the second chiplet is configured to grant, based on the second data, an encryption key associated with security of data stored in the first memory and data stored in the second memory to the virtual machine.

5. The chiplet system according to claim 2, wherein the first chiplet is configured to, in response to receiving a request associated with resource allocation for a virtual machine, allocate a computation resource that processes computation associated with the virtual machine to the first computation module and the second computation module while allocating a memory resource that stores data of the computation associated with the virtual machine to the first memory and the second memory,
the second chiplet is configured to grant, based on the second data, an encryption key associated with security of data stored in the first memory and data stored in the second memory to the virtual machine, and share the encryption key with the third chiplet, and
the third chiplet is configured to perform, based on the third data, security process on the data stored in the second memory by using the shared encryption key.

6. The chiplet system according to claim 2, wherein the first chiplet is further configured to:
in response to receiving a request associated with resource allocation for a first virtual machine and a second virtual machine, allocate a computation resource that processes computation associated with the first virtual machine to the first computation module while allocating a memory resource that stores data of the computation associated with the first virtual machine to the first memory, and
allocate a computation resource that processes computation associated with the second virtual machine to the second computation module while allocating a memory resource that stores data of the computation associated with the second virtual machine to the second memory,
the second chiplet is configured to grant, based on the second data, a first encryption key associated with security of data stored in the first memory to the first virtual machine, and
the third chiplet is configured to grant, based on the third data, a second encryption key associated with security of data stored in the second memory to the second virtual machine.

7. The chiplet system according to claim 1, wherein the first chiplet is further configured to, in response to receiving a request associated with resource allocation for a first virtual machine and a second virtual machine, allocate a computation resource that processes computations associated with the first virtual machine and the second virtual machine to the first computation module while allocating a memory resource that stores data of the computations associated with the first virtual machine and the second virtual machine to the first memory, and
the second chiplet is configured to:
grant, based on the second data, a first encryption key associated with security of data that is associated with the first virtual machine among the data stored in the first memory to the first virtual machine, and
grant, based on the second data, a second encryption key associated with security of data that is associated with the second virtual machine among the data stored in the first memory to the second virtual machine.

8. The chiplet system according to claim 1, further comprising:
a third chiplet comprising a fourth interface for communicating with a second external device and a third RoT in which tamper-resistant third data is stored; and
a fourth chiplet comprising a fifth interface for communicating with a second memory, a fourth RoT in which tamper-resistant fourth data is stored, and a second computation module that performs computation using data stored in the second memory,
wherein the third chiplet is configured to:
obtain, from the fourth chiplet, through a sixth interface for communication between the third chiplet and the fourth chiplet, information on a security state of the fourth chiplet based on the fourth data,
generate, based on information on a security state of the third chiplet based on the third data and the information on the security state of the fourth chiplet obtained from the fourth chiplet, second monitoring information, and
transmit the second monitoring information to the second external device through the fourth interface.

9. The chiplet system according to claim 1, further comprising:
a third chiplet comprising a fourth interface for communicating with the first chiplet and a third RoT in which tamper-resistant third data is stored, and
a fourth chiplet comprising a fifth interface for communicating with a second memory, a fourth RoT in which tamper-resistant fourth data is stored, and a second computation module that performs computation using data stored in the second memory,
wherein the third chiplet is configured to:
obtain, from the fourth chiplet, through a sixth interface for communication between the third chiplet and the fourth chiplet, information on a security state of the fourth chiplet based on the fourth data,
generate, based on information on a security state of the third chiplet based on the third data and the information on the security state of the fourth chiplet obtained from the fourth chiplet, second monitoring information, and
transmit the second monitoring information to the first chiplet through the fourth interface, and
the first monitoring information is generated based on information on a security state of the first chiplet based on the first data, information on a security state of the second chiplet obtained from the second chiplet, and the second monitoring information obtained from the third chiplet.

10. The chiplet system according to claim 1, wherein the information on the security state of the first chiplet comprises at least one of information on integrity verification of firmware operating in the first chiplet or information on real-time integrity verification of at least a portion of data being used in the first chiplet, and
the information on the security state of the second chiplet comprises at least one of information on integrity verification of firmware operating in the second chiplet or information on real-time integrity verification of at least a portion of data in use in the second chiplet.

11. A security method of a chiplet system comprising a plurality of chiplets,
the chiplet system comprising:
a first chiplet comprising a first interface for communicating with a first external device and a first RoT (root of trust) in which tamper-resistant first data is stored, and
a second chiplet comprising a second interface for communicating with a first memory, a second RoT in which tamper-resistant second data is stored, and a first computation module that performs computation using data stored in the first memory,
the method comprising:
obtaining, by the first chiplet, from the second chiplet, through a third interface for communication between the first chiplet and the second chiplet, information on a security state of the second chiplet based on the second data;
generating, by the first chiplet, based on information on a security state of the first chiplet based on the first data and the information on the security state of the second chiplet obtained from the second chiplet, first monitoring information; and
transmitting, by the first chiplet, the first monitoring information to the first external device through the first interface.

12. The security method of the chiplet system according to claim 11, further comprising obtaining, by the first chiplet, from a third chiplet, through a fifth interface for communication between the second chiplet and a third chiplet, and the third interface, information on a security state of the third chiplet based on the third data, wherein the third chiplet comprises a fourth interface for communicating with a second memory, a third RoT in which tamper-resistant third data is stored, and a second computation module that performs computation using data stored in the second memory, and
the generating the first monitoring information comprises generating, by the first chiplet, based on the information on the security state of the first chiplet based on the first data, the information on the security state of the second chiplet obtained from the second chiplet, and the information on the security state of the third chiplet obtained from the third chiplet, the first monitoring information.

13. The security method of the chiplet system according to claim 12, further comprising obtaining, by the first chiplet, from the fourth chiplet, through a seventh interface between the third chiplet and a fourth chiplet, the fifth interface, and the third interface, information on a security state of the fourth chiplet based on the fourth data, wherein the fourth chiplet comprises a sixth interface for communicating with a third memory, a fourth RoT in which tamper-resistant fourth data is stored, and a third computation module that performs computation using data stored in the third memory,
the generating the first monitoring information comprises generating, by the first chiplet, the first monitoring information, based on the information on the security state of the first chiplet based on the first data, the information on the security state of the second chiplet obtained from the second chiplet, the information on the security state of the third chiplet obtained from the third chiplet, and the information on the security state of the fourth chiplet obtained from the fourth chiplet.

14. The security method of the chiplet system according to claim 12, further comprising:
in response to receiving a request associated with resource allocation for a virtual machine, allocating, by the first chiplet, a computation resource that processes computation associated with the virtual machine to the first computation module while allocating a memory resource that stores data of the computation associated with the virtual machine to the first memory and the second memory; and
granting, by the second chiplet, based on the second data, an encryption key associated with security of data stored in the first memory and data stored in the second memory to the virtual machine.

15. The security method of the chiplet system according to claim 12, further comprising:
in response to receiving a request associated with resource allocation for a virtual machine, allocating, by the first chiplet, a computation resource that processes computation associated with the virtual machine to the first computation module and the second computation module while allocating a memory resource that stores data of the computation associated with the virtual machine to the first memory and the second memory;
granting, by the second chiplet, based on the second data, an encryption key associated with security of data stored in the first memory and in the second memory to the virtual machine;
sharing, by the second chiplet, the encryption key with the third chiplet; and
performing, by the third chiplet based on the third data, security process on data stored in the second memory by using the shared encryption key.

16. The security method of the chiplet system according to claim 12, further comprising:
in response to receiving a request associated with resource allocation for a first virtual machine and a second virtual machine, allocating, by the first chiplet, a computation resource that processes computation associated with the first virtual machine to the first computation module while allocating a memory resource that stores data of the computation associated with the first virtual machine to the first memory, and allocating a computation resource that processes computation associated with the second virtual machine to the second computation module while allocating a memory resource that stores data of the computation associated with the second virtual machine to the second memory;
granting, by the second chiplet, based on the second data, a first encryption key associated with security of data stored in the first memory to the first virtual machine; and
granting, by the third chiplet, based on the third data, a second encryption key associated with security of data stored in the second memory to the second virtual machine.

17. The security method of the chiplet system according to claim 11, further comprising:
in response to receiving a request associated with resource allocation for a first virtual machine and a second virtual machine, allocating, by the first chiplet, a computation resource that processes computations associated with the first virtual machine and the second virtual machine to the first computation module while allocating a memory resource that stores data of the computations associated with the first virtual machine and the second virtual machine to the first memory; and
granting, by the second chiplet, based on the second data, a first encryption key associated with security of data that is associated with the first virtual machine among the data stored in the first memory to the first virtual machine, and a second encryption key associated with security of data that is associated with the second virtual machine among the data stored in the first memory to the second virtual machine.

18. The security method of the chiplet system according to claim 11, further comprising:
obtaining, by the third chiplet, from the fourth chiplet, through a sixth interface for communication between a third chiplet and a fourth chiplet, information on a security state of the fourth chiplet based on the fourth data, wherein the third chiplet comprises a fourth interface for communicating with a second external device and a third RoT in which tamper-resistant third data is stored, and the fourth chiplet comprises a fifth interface for communicating with a second memory, a fourth RoT in which tamper-resistant fourth data is stored, and a second computation module that performs computation using data stored in the second memory;
generating, by the third chiplet, based on information on a security state of the third chiplet based on the third data and the information on the security state of the fourth chiplet obtained from the fourth chiplet, second monitoring information; and
transmitting, by the third chiplet, the second monitoring information to the second external device through the fourth interface.

19. The security method of the chiplet system according to claim 11, further comprising:
obtaining, by the third chiplet, from the fourth chiplet, through a sixth interface for communication between a third chiplet and a fourth chiplet, information on a security state of the fourth chiplet based on the fourth data, wherein the third chiplet comprises a fourth interface for communicating with the first chiplet and a third RoT in which tamper-resistant third data is stored, and the fourth chiplet comprises a fifth interface for communicating with a second memory, a fourth RoT in which tamper-resistant fourth data is stored, and a second computation module that performs computation using data stored in the second memory;
generating, by the third chiplet, based on information on a security state of the third chiplet based on the third data and the information on the security state of the fourth chiplet obtained from the fourth chiplet, second monitoring information; and
transmitting, by the third chiplet, the second monitoring information to the first chiplet through the fourth interface,
wherein the generating the first monitoring information comprises generating, by the first chiplet, based on information on the security state of the first chiplet based on the first data, information on the security state of the second chiplet obtained from the second chiplet, and the second monitoring information obtained from the third chiplet, the first monitoring information.

20. The security method of the chiplet system according to claim 11, wherein the information on the security state of the first chiplet comprises at least one of information on integrity verification of firmware operating in the first chiplet or information on real-time integrity verification of at least a portion of data being used in the first chiplet, and
the information on the security state of the second chiplet comprises at least one of information on integrity verification of firmware operating in the second chiplet or information on real-time integrity verification of at least a portion of data being used in the second chiplet.
